(19) United States
(12) Patent Application Publication
(10) Pub. No.: US 2026/0219423 A1
(43) Pub. Date: Jul. 30, 2026

(54) CONTROLLED RELEASE OF DRY EYE RELIEF AGENT FROM CONTACT LENS

(71) Applicant: Alcon Inc., Fribourg (CH)

(72) Inventors: Steve Yun Zhang, Sugar Hill, GA (US); Jing Cheng, Irvine, CA (US); Feng Jing, Alpharetta, GA (US); Daqing Wu, Suwanee, GA (US); Newton T. Samuel, Suwanee, GA (US); Richard Charles Breitkopf, Dunwoody, GA (US); Thomas M. Moy, Cumming, GA (US); Frank Chang, Cumming, GA (US)

(21) Appl. No.: 19/462,134

(22) Filed: Jan. 28, 2026

Related U.S. Application Data
(60) Provisional application No. 63/750,951, filed on Jan. 29, 2025.

(51) Int. Cl. G02B 1/04; B65B 17/00; C08J 7/04

(52) U.S. Cl. CPC G02B 1/043; B65B 17/00; C08J 7/042; C08J 2383/04; C08J 2429/04; C08J 2433/14; C08J 2453/00

(57) ABSTRACT

Embodiments of the present disclosure generally relate to methods and processes for forming an ophthalmic product, such as contact lenses. More specifically, embodiments described herein relate to the production of contact lenses having a water-soluble phospholipid polymer disposed thereon, which may be released therefrom as an ophthalmic comfort agent during use of the contact lens. In some embodiments, a contact lens includes a bulk layer having a crosslinked polymeric material, and a poly(vinyl alcohol) (PVA) layer disposed on the bulk layer. The contact lens further includes a water-soluble phospholipid polymer disposed on the PVA layer. The water-soluble phospholipid polymer includes a plurality of phosphorylcholine units and a plurality of arylborono units.

### INTRODUCTION

Embodiments of the present disclosure generally relate to methods and processes for forming an ophthalmic product, such as contact lenses. More specifically, embodiments described herein relate to the production of contact lenses having a water-soluble phospholipid polymer disposed thereon, which may be released therefrom as an ophthalmic comfort agent during use of the contact lens.

### BACKGROUND

Dry eye disease is a multifactorial condition characterized by tear film instability and results in ocular discomfort and/or visual disturbance which can severely impact a patient's quality of life. Poly(2-methacryloyloxyethyl phosphorylcholine) (PMPC) has been found to be an effective dry eye relief agent when used in eye drops. Such PMPC polymers have been compared to other industry recognized ophthalmic comfort agents and has been shown to efficiently protect corneal cells at or above industry standard.

Current PMPC ophthalmic products are generally limited to eye drops and formulations thereof, as PMPC based contact lens coatings fail to provide adequate and/or sustained dry eye relief throughout the use and lifetime of the lens. Attempts to integrate PMPC based polymers into contact lens coatings typically suffer and/or fail from a lack of PMPC polymer interaction with the surface a contact lens (e.g., coating adherence to the contact lens), often leading to rapid and early onset reduction in the concentration of the dry eye relief agent. Such rapid reductions in dry eye relief agent concentration affect the efficacy by which the ophthalmic product can provide dry eye relief and/or the effective timeframe in which the relief is rendered. In other words, attempts at PMPC based contact lens coatings often lack the ability to provide long term and/or sustained dry eye relief throughout the useful lifetime of the contact lens.

Thus, there is a need for improved ophthalmic products for providing dry eye relief to a consumer.

### BRIEF SUMMARY

Embodiments of the present disclosure generally relate to methods and processes for forming an ophthalmic product, such as contact lenses. More specifically, embodiments described herein relate to the production of contact lenses having a water-soluble phospholipid polymer disposed thereon, which may be released therefrom as an ophthalmic comfort agent during use of the contact lens.

In some embodiments, a contact lens includes a bulk layer having a crosslinked polymeric material, and a poly(vinyl alcohol) (PVA) layer disposed on the bulk layer. The contact lens further includes a water-soluble phospholipid polymer disposed on the PVA layer. The water-soluble phospholipid polymer includes a plurality of phosphorylcholine units and a plurality of arylborono units.

In some embodiments, a contact lens includes a bulk layer having a plurality of hydroxyl groups on a surface thereof, and a phospholipid polymer disposed on the surface of the bulk layer. The phospholipid polymer includes a plurality of phosphorylcholine units and a plurality of vinylphenylboronic acid units. The plurality of the vinylphenylboronic acid units is bonded to at least a portion of the plurality of hydroxyl groups.

In some embodiments, a method for producing an ophthalmic product includes curing a lens-forming formulation to form a contact lens. The contact lens includes a crosslinked polymeric material and a plurality of hydroxyl groups. The plurality of hydroxyl groups are provided on a surface of the contact lens. The method further includes packaging the contact lens in a container containing a packaging solution. The packaging solution includes a water-soluble phospholipid polymer having a phosphorylcholine unit, an acrylate unit, and a vinylphenylboronic acid unit.

### BRIEF DESCRIPTION OF THE DRAWINGS

So that the manner in which the above recited features of embodiments of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic cross-sectional view of a coated contact lens, according to an embodiment.

FIG. 2 is a process flow diagram of a method for forming an ophthalmic product, according to an embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Unless defined otherwise, all technical and scientific terms used herein have the same meaning as commonly understood by one of ordinary skill in the art to which this disclosure belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

“Optional” or “optionally” means that the subsequently described event or circumstance can or cannot occur, and that the description includes instances where the event or circumstance occurs and instances where it does not.

A “contact lens” refers to a structure that can be placed on or within a wearer's eye. A contact lens can correct, improve, or alter a user's eyesight, but that need not be the case.

A “soft contact lens” refers to a contact lens which has an elastic modulus (i.e., Young's modulus) of less than 2.5 MPa.

As used in this application, the term “hydrogel” or “hydrogel material” refers to a crosslinked polymeric material which is insoluble in water, but can hold at least 10 percent by weight of water in its three-dimensional polymer networks (i.e., polymer matrix) when it is fully hydrated.

As used in this application, the term “non-silicone hydrogel” refers to a hydrogel that is substantially or completely free of silicon.

As used in this application, the term “silicone hydrogel” refers to a hydrogel containing silicone. A silicone hydrogel typically is obtained by copolymerization of a polymerizable composition comprising at least one silicone-containing vinylic monomer or at least one silicone-containing vinylic macromer or at least one silicone-containing prepolymer having ethylenically unsaturated groups.

A “vinylic monomer” refers to a compound that has one sole ethylenically-unsaturated group.

The term “soluble”, in reference to a compound or material in a solvent, means that the compound or material can be dissolved in the solvent to give a solution with a concentration of at least about 0.1% by weight at room temperature (e.g., from about 20° C. to about 30° C.).

The term “insoluble”, in reference to a compound or material in a solvent, means that the compound or material can be dissolved in the solvent to give a solution with a concentration of less than 0.005% by weight at room temperature (as defined above).

The term “ethylenically unsaturated group” is employed herein in a broad sense and is intended to encompass any groups containing at least one >C═C< group. Exemplary ethylenically unsaturated groups include (meth)acryloyl

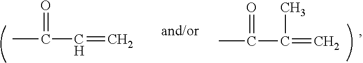

allyl, vinyl (—CH═CH₂) 1-methylethenyl

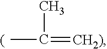

styrenyl, or the likes.

The term “(meth)acrylamide” refers to methacrylamide and/or acrylamide.

The term “(meth)acrylate” refers to methacrylate and/or acrylate.

A “hydrophilic vinylic monomer”, as used herein, refers to a vinylic monomer which can be polymerized to form a homopolymer that is water-soluble or can absorb at least 10 percent by weight of water.

A “hydrophobic vinylic monomer” refers to a vinylic monomer which can be polymerized to form a homopolymer that is insoluble in water and can absorb less than 10 percent by weight of water.

An “acrylic monomer” refers to a vinylic monomer having one sole (meth)acryloyl group.

An “N-vinyl amide monomer” refers to an amide compound having a vinyl group (—CH═CH₂) that is directly attached to the nitrogen atom of the amide group.

As used in this application, the term “vinylic crosslinker” refers to a compound having at least two ethylenically unsaturated groups. A “vinylic crosslinking agent” refers to a subclass of vinylic crosslinkers each having a number average molecular weight of 700 Daltons or less.

As used in this application, the term “macromer” or “prepolymer” refers to a medium and high molecular weight compound or polymer that contains two or more ethylenically unsaturated groups. Medium and high molecular weight typically means number average molecular weights greater than 700 Daltons.

A “polysiloxane segment” refers to a polymer chain consisting of at least three consecutively and/or directly linked siloxane units (divalent radical) each independent of one another having a formula of

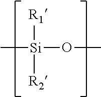

in which R₁′ and R₂′ are two substituents independently selected from C₁-C₁₀ alkyl, C₁-C₄ alkyl- or C₁-C₄-alkoxy-substituted phenyl, C₁-C₁₀ fluoroalkyl, C₁-C₁₀ fluoroether, C₆-C₁₈ aryl radical, -alk-(OC₂H₄)_{γ1}—OR^{∘} (in which alk is C₁-C₆ alkyl diradical, R^{∘} is H or C₁-C₄ alkyl and γ1 is an integer from 1 to 10), a C₂-C₄₀ organic radical having at least one functional group selected from hydroxyl group (—OH), carboxyl group (—COOH), —NR₃′R₄′, amino linkages of —NR₃′—, amide linkages of —CONR₃′—, amide of —CONR₃′R₄′, urethane linkages of —OCONH—, and C₁-C₄ alkoxy group, or a linear hydrophilic polymer chain, in which R₃′ and R₄′ independent of each other are hydrogen or a C₁-C₁₅ alkyl.

A “polysiloxane vinylic monomer” refers to a compound comprising at least one polysiloxane segment and one sole ethylenically-unsaturated group.

A “polysiloxane vinylic crosslinker” refers to a compound comprising at least one polysiloxane segment and at least two ethylenically-unsaturated groups.

A “chain-extended polysiloxane vinylic crosslinker” refers to a compound comprising at least two ethylenically-unsaturated groups and at least two polysiloxane segments each pair of which is linked by one divalent radical.

As used in this application, the term “polymer” means a material formed by polymerizing/crosslinking one or more monomers or macromers or prepolymers.

As used in this application, the term “molecular weight” of a polymeric material (including monomeric or macromeric materials) refers to the number-average molecular weight unless otherwise specifically noted or unless testing conditions indicate otherwise. A person skilled in the art knows how to determine the molecular weight of a polymer according to known methods, e.g., GPC (gel permeation [symbol] chromatography) with one or more of a refractive index detector, a low-angle laser light scattering detector, a multi-angle laser light scattering detector, a differential viscometry detector, a UV detector, and an infrared (IR) detector; MALDI-TOF MS (matrix-assisted desorption/ionization time-of-flight mass spectroscopy); ¹H NMR spectroscopy, etc.

The term “alkyl” refers to a monovalent radical obtained by removing a hydrogen atom from a linear or branched alkane compound. An alkyl group (radical) forms one bond with one other group in an organic compound.

The term “alkylene divalent radical” or “alkylene diradical” or “alkyl diradical” interchangeably refers to a divalent radical obtained by removing one hydrogen atom from an alkyl. An alkylene divalent group forms two bonds with other groups in an organic compound.

The term “alkoxy” or “alkoxyl” refers to a monovalent radical obtained by removing the hydrogen atom from the hydroxyl group of a linear or branched alkyl alcohol. An alkoxy group (radical) forms one bond with one other group in an organic compound.

In this application, the term “substituted” in reference to an alkyl diradical or an alkyl radical means that the alkyl diradical or the alkyl radical comprises at least one substituent which replaces one hydrogen atom of the alkyl diradical or the alkyl radical and is selected from hydroxy (—OH), carboxy (—COOH), —NH₂, sulfhydryl (—SH), C₁-C₄ alkyl, C₁-C₄ alkoxy, C₁-C₄ alkylthio (alkyl sulfide), C₁-C₄ acylamino, C₁-C₄ alkylamino, di-C₁-C₄ alkylamino, halogen atom (Br or Cl), and combinations thereof.

In this application, an “arylborono” group refers to a monovalent radical of

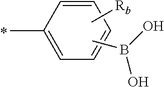

in which R_{b} is H, NO₂, F, Cl, or CF₃, and b is an integer of 1 to 4 based on the number of boronic acid groups present on the phenyl ring.

As used in this application, the term “phosphorylcholine” (hereinafter designated as “PC”) refers to a monovalent zwitterionic group of

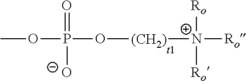

in which t1 is an integer of 1 to 5 and R₀, R₀′ and R₀″ independently of one another are C₁-C₄ alkyl.

An “initiator” refers to a chemical that can initiate free radical polymerizing reaction.

A “coated contact lens” refers to a bulk contact lens with a coating composition deposited on a surface thereof.

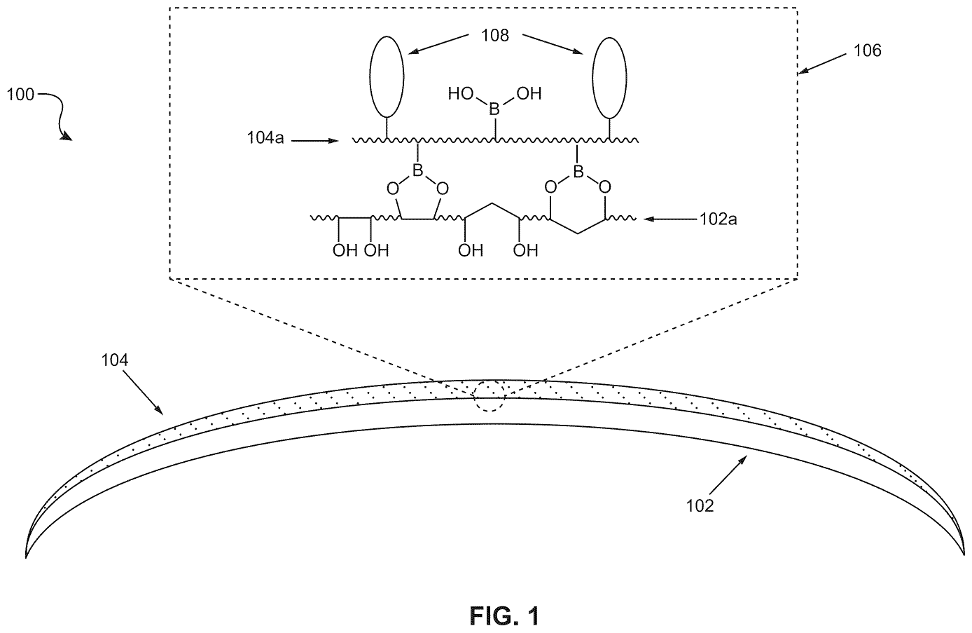

A “spatial limitation of actinic radiation” refers to a process in which energy radiation in the form of rays is directed by, for example, a mask or screen or combinations thereof, to impinge, in a spatially restricted manner, onto an area having a well-defined peripheral boundary. A spatial limitation of UV radiation is obtained by using a mask or screen having a radiation (e.g., UV and/or visible light) permeable region, a radiation (e.g., UV and/or visible light) impermeable region surrounding the radiation-permeable region, and a projection contour which is the boundary between the radiation-impermeable and radiation-permeable regions, as schematically illustrated in the drawings of U.S. Pat. No. 6,800,225 (FIGS. 1-11), and U.S. Pat. No. 6,627,124 (FIGS. 1-9), U.S. Pat. No. 7,384,590 (FIGS. 1-6), and U.S. Pat. No. 7,387,759 (FIGS. 1-6). The mask or screen allows to spatially projects a beam of radiation (e.g., UV radiation and/or visible radiation) having a cross-sectional profile defined by the projection contour of the mask or screen. The projected beam of radiation (e.g., UV radiation and/or visible radiation) limits radiation impinging on a lens formulation located in the path of the projected beam from the first molding surface to the second molding surface of a mold. The resultant contact lens comprises an anterior surface defined by the first molding surface, an opposite posterior surface defined by the second molding surface, and a lens edge defined by the sectional profile of the projected UV and/or visible beam (i.e., a spatial limitation of radiation). The radiation used for the crosslinking is radiation energy, especially UV radiation (and/or visible radiation), gamma radiation, electron radiation or thermal radiation. The radiation energy may be in the form of a substantially parallel beam in order to achieve good restriction and/or efficient use of the energy.

The term “modulus” or “elastic modulus” in reference to a contact lens or a material means the tensile modulus or Young's modulus which is a measure of the stiffness of a contact lens or a material. The modulus can be measured using a method in accordance with ANSI Z80.20 standard.

“UVA” refers to radiation occurring at wavelengths between 315 and 380 nanometers; “UVB” refers to radiation occurring between 280 and 315 nanometers; “Violet” refers to radiation occurring at wavelengths between 380 and 440 nanometers.

“UVA transmittance” (or “UVA % T”), “UVB transmittance” or “UVB % T”, and “violet-transmittance” or “Violet % T” are calculated by the following formula

$$UVA \% T = \frac{Average \% Transmission between 315 nm and 380 nm}{Luminescence \% T} \times 100$$

$$UVB \% T = \frac{Average \% Transmission between 280 nm and 315 nm}{Luminescence \% T} \times 100$$

$$Violet \% T = \frac{Average \% Transmission between 380 nm and 440 nm}{Luminescence \% T} \times 100$$

in which Luminescence % T is determined by the following formula

$$Luminescence \% T = Average \% Transmission between 780 nm and 380 nm$$

“Surface modification” or “surface treatment”, as used herein, means that an article has been treated in a surface treatment process (or a surface modification process) prior to or posterior to the formation of the article, in which (1) a coating is applied to the surface of the article, (2) chemical species are adsorbed onto the surface of the article, (3) the chemical nature (e.g., electrostatic charge) of chemical groups on the surface of the article are altered, or (4) the surface properties of the article are otherwise modified. Exemplary surface treatment processes include a surface treatment by energy (e.g., a plasma, a static electrical charge, irradiation, or other energy source), chemical treatments, the grafting of hydrophilic vinylic monomers or macromers onto the surface of an article, mold-transfer coating process disclosed in U.S. Pat. No. 6,719,929, the incorporation of wetting agents into a lens formulation for making contact lenses proposed in U.S. Pat. Nos. 6,367,929 and 6,822,016, reinforced mold-transfer coating disclosed in U.S. Pat. No. 7,858,000, and a hydrophilic coating composed of covalent attachment or physical deposition of one or more layers of one or more hydrophilic polymer onto the surface of a contact lens disclosed in U.S. Pat. Nos. 8,147,897 and 8,409,599 and US Pat. Appl. Pub. Nos. 2011-0134387 A1, 2012-0026457 A1, and 2013-0118127 A1.

“Post-curing surface treatment”, in reference to a silicone hydrogel bulk material or a SiHy contact lens, means a surface treatment process that is performed after the silicone hydrogel bulk material or the SiHy contact lens is formed by curing (e.g., thermally or actinically polymerizing) a SiHy lens formulation. A “SiHy lens formulation” refers to a polymerizable composition that comprises all necessary polymerizable components for producing a SiHy contact lens or a SiHy lens bulk material as well known to a person skilled in the art.

In general, the present disclosure is directed to uses of a phosphorylcholine (e.g., poly(2-methacryloyloxyethyl phosphorylcholine), alternatively referred to as “PMPC”) based polymers as a leachable lubricant for soft contact lenses. More specifically, PMPC based polymers may be coated onto a contact lens surface during preparation of a contact lens ophthalmic product. Without being bound by theory, the PMPC based polymers may be coated onto a contact lens surface via a reversible bonding mechanism (e.g., a dynamic covalent chemistry) between a phenyl boronic acid moiety present in the composition of the PMPC based polymer and a 1,2- and/or a 1,3-diol group present on a surface of a contact lens. Without being bound by theory, during use of the contact lens, the PMPC based polymer may be released from the contact lens via the reversible bonding mechanism to provide dry eye relief.

FIG. 1 is a cross-sectional view of a coated contact lens 100, according to one or more embodiments. In some embodiments, a coated contact lens 100 of the present disclosure includes a bulk layer 102 (e.g., a bulk lens material) and a coating 104 (e.g., a hydrogel coating) deposited on a surface thereof. An interface 106 is formed between the bulk layer 102 and the coating 104 via one or more interactions between the respective surface compositions of each of the bulk layer 102 and coating 104. The bulk layer 102 may include a cross-linked polymeric material having a plurality of hydroxyl groups disposed on a surface of the bulk layer 102, providing a surface composition 102a. The plurality of hydroxyl groups may be accessible from the surface of the bulk layer 102 such that a foreign compound (e.g., water soluble phospholipid polymer layer), coating, or biological species may be attracted and/or bonded (covalently and/or by any one or more secondary interactions known to one of ordinary skill in the art) to the surface composition 102a of the bulk layer 102. Such bonding may be reversible or permanent. In at least one embodiment, the coating 104 includes a water soluble phospholipid polymer (e.g., a PMPC based polymer) such that the surface composition 104a of the coating 104 includes a plurality of therapeutic agents 108 and a plurality of boronic acid moieties. The plurality of boronic acid moieties present in the surface composition 104a of the coating 104 are capable of interacting with the plurality of hydroxyl groups present in the surface composition 102a of the bulk layer 102 to form the interface 106.

In some embodiments, the plurality of hydroxyl groups present in the surface composition 102a of the bulk layer 102 are provided thereto via the composition of the bulk layer 102, a coating (not shown) disposed on the bulk layer 102, a surface treatment applied to the surface of the bulk layer 102, or a combination thereof.

In at least one embodiment, the coating 104 includes a hydrogel. In at least one embodiment, the coating 104 is a hydrogel coating. In at least one embodiment, the coating 104 is a hydrogel formed from the interaction between the plurality of boronic acid moieties present in the surface composition 104a of the coating 104 and the plurality of hydroxyl groups present in the surface composition 102a of the bulk layer 102. In at least one embodiment, the coating 104 includes a PMPC based polymer and/or a reaction product derived therefrom (e.g., the interface 106).

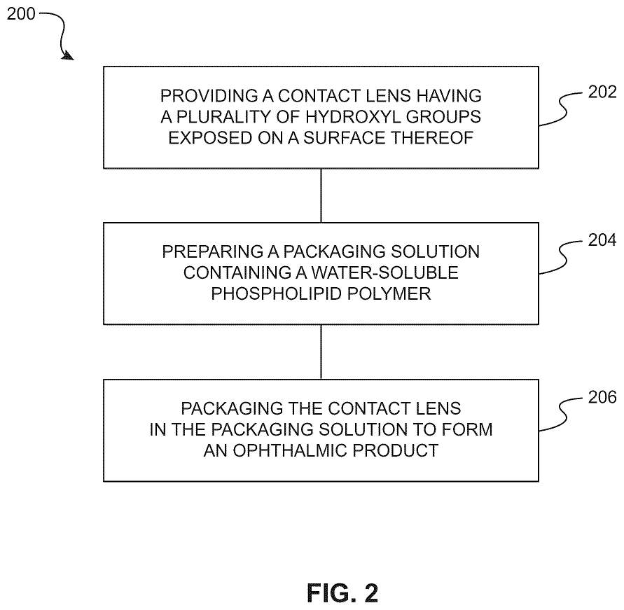

FIG. 2 is a process flow diagram of a method 200 for forming an ophthalmic product, such as coated contact lens 100, according to one or more embodiments. In operation 202 of the method 200, a contact lens (e.g., the bulk layer 102) having a plurality of hydroxyl groups exposed on a surface thereof is provided. The contact lens may be provided as a preformed contact lens and/or prepared via curing a contact lens formulation by any method or process known to one of ordinary skill in the art. In operation 204 of the method 200, a packaging solution is prepared via any one or more methods known to one of ordinary skill in the art. The packaging solution may be an aqueous solution containing a water soluble phospholipid polymer, such as a PMPC based polymer. In operation 206 of the method 200, the contact lens is packaged in the packaging solution to form the ophthalmic product.

The present disclosure provides process(es) for producing coated contact lenses, each having a coating thereon. A coated contact lens 100 of the present disclosure may be prepared by obtaining a preformed contact lens and forming a base coating on the preformed contact lens. The base coating may be formed according to a solution-coating process including contacting the preformed contact lens with a coating solution for a first period of time at a first temperature of from about 20° C. to about 65° C. to form a treated contact lens. The treated contact lens may then be rinsed with water or an aqueous solution for a second period of time at a second temperature. In various embodiments, the second temperature is lower than the first temperature. The treated contact lens may then be contacted with an aqueous reactive coating solution (e.g., a packaging solution) to dispose a hydrogel coating over a surface thereof to form a coated contact lens 100. In some embodiments, the aqueous reactive solution includes a water-soluble phospholipid polymer having a plurality of phosphorylcholine units.

In some embodiments, the bulk layer 102 of the coated contact lens 100 includes a crosslinked polymeric material, such as a non-silicone hydrogel material or a silicone hydrogel material. In at least one embodiment, the bulk layer 102 includes a soft contact lens prepared by any one or more methods known to one of ordinary skill in the art. Soft contact lenses can be produced in a conventional “spin-casting mold,” as described, for example, in U.S. Pat. No. 3,408,429, or by the full cast-molding process in a static form, as described in U.S. Pat. Nos. 4,347,198; 5,508,317; 5,583,463; 5,789,464; and 5,849,810, incorporated herein for disclosures relating to cast-molding processes, or by lathe cutting of polymeric material buttons as used in making customized contact lenses. In cast-molding, a polymerizable composition (or lens formulation) typically is dispensed into molds and cured (e.g., polymerized and/or crosslinked) in molds for making contact lenses.

Lens molds for making contact lenses may be employed in cast molding or spin casting. The lens molds may be prepared and/or configured by any suitable means known to one of ordinary skill in the art. For example, a mold (for cast molding) generally comprises at least two mold sections (or portions) or mold halves, e.g. first and second mold halves. The first mold half defines a first molding (or optical) surface and the second mold half defines a second molding (or optical) surface. The first and second mold halves are configured to receive each other such that a lens forming cavity is formed between the first molding surface and the second molding surface. The molding surface of a mold half is the cavity-forming surface of the mold and in direct contact with lens-forming material. Examples of suitable processes for forming the mold halves are disclosed in U.S. Pat. Nos. 4,444,711; 4,460,534; 5,843,346; and 5,894,002, incorporated herein by reference for said processes and mold halves. Virtually all materials known in the art for making molds can be used to make molds for making contact lenses.

In some embodiments, reusable molds are used and the lens-forming composition is cured actinically under a spatial limitation of actinic radiation to form a contact lens. Examples of reusable molds are disclosed in U.S. Pat. Nos. 6,627,124, 6,800,225, 7,384,590, and 7,387,759, incorporated herein by reference for said reusable molds. Reusable molds can be made of quartz, glass, sapphire, CaF2, a cyclic olefin copolymer (e.g., Topas® COC grade 8007-510 (clear amorphous copolymer of ethylene and norbornene) from Ticona GmbH of Frankfurt, Germany and Summit, N.J., Zeonex® and Zeonor® from Zeon Chemicals LP, Louisville, Ky.), polymethylmethacrylate (PMMA), polyoxymethylene from DuPont (Delrin), Ultem® (polyetherimide) from G.E. Plastics, PrimoSpire®, etc.

The lens formulation can be introduced (dispensed) into a cavity formed by a mold according to any suitable method(s) known to one of ordinary skill in the art. Once dispensed into the cavity, the lens formulation is polymerized to produce a contact lens. Such a contact lens may be used as the bulk layer 102 of a coated contact lens 100. As previously discussed, the bulk layer 102 may include a crosslinked polymeric material formed via the polymerization (e.g., curing) of the lens formulation. Polymerization of the lens formulation may be initiated thermally or actinically. In at least one embodiment, the lens formulation is cured by exposure to a spatial limitation of actinic radiation. Once cured, either fully or partially, the bulk layer 102 may be removed from the mold via any suitable manner known to one of ordinary skill in the art.

In at least one embodiment, the bulk layer 102 is subjected to a lens extraction operation to remove unpolymerized and/or partially polymerized components of the lens formulation. In other words, components of the lens formulation that are not covalently bound to the crosslinked polymeric material, and/or entrapped/entangled therein, are removed therefrom via the lens extraction operation.

Preformed contact lenses to be used as a bulk layer 102 for a coated contact lens 100 can include a non-silicone hydrogel contact lens. Such non-silicone hydrogel contact lenses can be commercially available or be produced via any suitable method known to one of ordinary skill in the art. In some embodiments, a non-silicone hydrogel lens formulation includes a monomer mixture having at least one hydrophilic vinylic monomer (e.g., hydroxyethyl methacrylate, glycerol methacrylate, N-vinylpyrrolidone, vinyl acrylate, or combinations thereof) and at least one component selected from a crosslinking agent, a lubricating agent (or so-called internal wetting agents incorporated in a lens formulation), a free-radical initiator (photoinitiator or thermal initiator), a UV-absorbing vinylic monomer, a high energy-violet-light (HEVL) absorbing vinylic monomer, a visibility tinting agent (e.g., reactive dyes, polymerizable dyes, pigments, or mixtures thereof), antimicrobial agents (e.g., silver nanoparticles), a bioactive agent, and combinations thereof. In some embodiments, a non-silicone hydrogel lens formulation includes an aqueous solution having one or more water-soluble prepolymers and at least one component selected from a hydrophilic vinylic monomer, a crosslinking agent, a hydrophobic vinylic monomer, a lubricating agent (or so-called internal wetting agents incorporated in a lens formulation), a free radical initiator (photoinitiator or thermal initiator), a UV absorbing vinylic monomer, a HEVL absorbing vinylic monomer, a visibility tinting agent (e.g., reactive dyes, polymerizable dyes, pigments, or mixtures thereof), antimicrobial agents (e.g., silver nanoparticles), a bioactive agent, and combinations thereof.

Preformed hydrogel contact lenses formed via curing the non-silicone hydrogel lens formulation may be subjected to the extraction operation, which uses an extraction solvent to remove unpolymerized and/or partially polymerized components from the produced bulk layer 102. Additionally and/or alternatively, the preformed hydrogel contact lenses may be subjected to a hydration operation. In at least one embodiment, the extraction operation may serve as the hydration operation. The hydration operation may be any suitable hydration operation known to one of ordinary skill in the art.

In some embodiments, water-soluble can include, but is not limited to, a water-soluble crosslinkable poly(vinyl alcohol) prepolymer described in U.S. Pat. Nos. 5,583,163 and 6,303,687; a water-soluble vinyl group-terminated polyurethane prepolymer described in U.S. Pat. No. 6,995,192; derivatives of a polyvinyl alcohol, polyethyleneimine or polyvinylamine, which are disclosed in U.S. Pat. No. 5,849,841; a water-soluble crosslinkable polyurea prepolymer described in U.S. Pat. Nos. 6,479,587 and 7,977,430; crosslinkable polyacrylamide; crosslinkable statistical copolymers of vinyl lactam, MMA and a comonomer, which are disclosed in U.S. Pat. No. 5,712,356; crosslinkable copolymers of vinyl lactam, vinyl acetate and vinyl alcohol, which are disclosed in U.S. Pat. No. 5,665,840; polyether-polyester copolymers with crosslinkable side chains which are disclosed in U.S. Pat. No. 6,492,478; branched polyalkylene glycol-urethane prepolymers disclosed in U.S. Pat. No. 6,165,408; polyalkylene glycol-tetra(meth)acrylate prepolymers disclosed in U.S. Pat. No. 6,221,303; crosslinkable polyallylamine gluconolactone prepolymers disclosed in U.S. Pat. No. 6,472,489; said patents incorporated herein by reference for the purposes of said chemical compounds.

In some embodiments, the non-silicone hydrogel lens formulation includes a commercial non-silicone hydrogel lens formulation. The commercial non-silicone hydrogel lens formulation may include one or more of alfafilcon A, acofilcon A, deltafilcon A, etafilcon A, focofilcon A, helfilcon A, helfilcon B, hilafilcon B, hioxifilcon A, hioxifilcon B, hioxifilcon D, methafilcon A, methafilcon B, nelfilcon A, nesofilcon A, ocufilcon A, ocufilcon B, ocufilcon C, ocufilcon D, omafilcon A, phemfilcon A, polymacon, samfilcon A, telfilcon A, tetrafilcon A, and vifilcon A.

In some embodiments, the crosslinked polymeric material as bulk layer 102 of a coated contact lens 100 of the present disclosure is composed of a non-silicone hydrogel material which comprises at least 50 mol % repeating units of at least one hydroxyl-containing vinylic monomer selected from hydroxyethyl (meth)acrylate, glycerol (meth)acrylate, 3-hydroxypropyl (meth)acrylate, 2-hydroxypropyl (meth)acrylate, 3-amino-2-hydroxypropyl (meth)acrylate, N-2-hydroxyethyl (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, allyl alcohol, and combinations thereof. In at least one embodiment, the at least one hydroxyl-containing vinylic monomer is selected from hydroxyethyl (meth)acrylate and glycerol (meth)acrylate. The mole percentages of repeating units can be calculated based on a non-silicone hydrogel lens formulation for making the non-silicone hydrogel contact lens.

In some embodiments, the crosslinked polymeric material used as the bulk layer 102 includes a non-silicone hydrogel material having at least 50 mol % of repeating units of vinyl alcohol, such as at least 60 mol %, such as at least 70 mol %, such as at least 75 mol %. In one or more embodiments, the crosslinked polymeric material used as the bulk layer 102 includes a non-silicone hydrogel material is a crosslinking product of at least one water-soluble actinically-polymerizable polyvinyl alcohol prepolymer in the presence or absence of a vinylic monomer and/or vinylic crosslinking agent. A water-soluble actinically-polymerizable polyvinyl alcohol prepolymer may be prepared via any suitable method known to one of ordinary skill in the art, such as those disclosed in U.S. Pat. Nos. 5,583,163 and 6,303,687 and U.S. Pat. Appl. Pub. No. 2017/0158611A1, incorporated herein by reference for said prepolymers and methods.

In some embodiments, the polyvinylalcohol prepolymers are purified in a manner known to one of ordinary skill in the art, such as by precipitation with organic solvents (e.g., acetone), filtration and washing, extraction in a suitable solvent, dialysis, or ultrafiltration. The prepolymers can be obtained in high purity form such that concentrated aqueous solutions of the prepolymer are free, or at least substantially free, from reaction products (e.g., salts) and other starting materials (e.g., non-polymeric constituents).

In one or more embodiments, the prepolymer purification process includes ultrafiltration, and can be carried out in a manner known to one of ordinary skill in the art. It may be possible for the ultrafiltration to be carried out repeatedly (e.g., from two to ten times). Alternatively, the ultrafiltration can be carried out continuously until the selected degree of purity is attained. The selected degree of purity can be as high as desired (e.g., about 90% purity or greater). The concentration of dissolved salts obtained as by-products, as determined by any method known to one of ordinary skill in the art, may be used to determine the degree of purity of the prepolymer.

It may be desirable for the water-soluble actinically-polymerizable polyvinylalcohol prepolymers to have a substantially pure form (e.g., purified by ultrafiltration to remove most reactants for forming the prepolymer), so that after crosslinking by actinic radiation, a contact lens may require practically no more subsequent purification (e.g., extraction of unpolymerized constituents). Furthermore, crosslinking may take place in an aqueous solution such that a subsequent solvent exchange or the hydration step is not necessary.

A polyvinylalcohol-based hydrogel contact lens may be obtained by introducing an aqueous lens-forming composition including a water-soluble, actinically-polymerizable polyvinyl alcohol prepolymer described above and a crosslinking agent (sometimes referred to as a crosslinker) into a reusable mold and curing under a spatial limitation of actinic radiation the aqueous lens-forming composition.

In at least one embodiment, the crosslinked polymeric material as bulk layer 102 of a coated contact lens 100 is a silicone hydrogel material including repeating units of at least one silicone-containing vinylic monomer and/or at least one silicone-containing vinylic crosslinker, and repeating units of at least one hydrophilic vinylic monomer.

In some embodiments, a silicone-containing vinylic monomer includes any silicone-containing vinylic monomer known to a person of ordinary skill in the art. Silicone-containing vinylic monomers may include monomers having a bis(trialkylsilyloxy)alkylsilyl group or a tris(trialkylsilyloxy)silyl group, polysiloxane vinylic monomers, 3-methacryloxy propylpentamethyldisiloxane, t-butyldimethyl-siloxyethyl vinyl carbonate, trimethylsilylethyl vinyl carbonate, trimethylsilylmethyl vinyl carbonate, and combinations thereof.

A vinylic monomer having a bis(trialkylsilyloxy)alkylsilyl group or a tris(trialkylsilyloxy)silyl group may include one or more of tris(trimethylsilyloxy)-silylpropyl (meth)acrylate, [3-(meth)acryloxy-2-hydroxypropyloxy]propylbis(trimethylsiloxy)-methylsilane, [3-(meth)acryloxy-2-hydroxypropyloxy]propylbis(trimethylsiloxy)butylsilane, 3-(meth)acryloxy-2-(2-hydroxyethoxy)-propyloxy) propylbis(trimethylsiloxy)methylsilane, 3-(meth)acryloxy-2-hydroxypropyloxy) propyltris(trimethylsiloxy)silane, N-[tris(trimethylsiloxy)-silylpropyl]-(meth)acrylamide, N-(2-hydroxy-3-(3-(bis(trimethylsilyloxy)methylsilyl)propyloxy)-propyl)-2-methyl (meth)acrylamide, N-(2-hydroxy-3-(3-(bis(trimethylsilyloxy)methylsilyl)-propyloxy)propyl) (meth)acrylamide, N-(2-hydroxy-3-(3-(tris(trimethylsilyloxy)silyl)propyloxy)-propyl)-2-methyl acrylamide, N-(2-hydroxy-3-(3-(tris(trimethylsilyloxy)silyl)propyloxy)propyl) (meth)acrylamide, N-[tris(dimethylpropylsiloxy)silylpropyl]-(meth)acrylamide, N-[tris(dimethylphenylsiloxy)silylpropyl](meth)acrylamide, N-[tris(dimethylethylsiloxy)silylpropyl](meth)acrylamide, N,N-bis[2-hydroxy-3-(3-(bis(trimethylsilyloxy)methylsilyl)propyloxy)propyl]-2-methyl (meth)acrylamide, N,N-bis[2-hydroxy-3-(3-(bis(trimethylsilyloxy)methylsilyl)-propyloxy)propyl](meth)acrylamide, N,N-bis[2-hydroxy-3-(3-(tris(trimethylsilyloxy)silyl)-propyloxy)propyl]-2-methyl (meth)acrylamide, N,N-bis[2-hydroxy-3-(3-(tris(trimethylsilyloxy)-silyl) propyloxy)propyl](meth)acrylamide, N-[2-hydroxy-3-(3-(t-butyldimethylsilyl)propyloxy)-propyl]-2-methyl (meth)acrylamide, N-[2-hydroxy-3-(3-(t-butyldimethylsilyl)propyloxy)propyl](meth)acrylamide, N,N-bis[2-hydroxy-3-(3-(t-butyldimethylsilyl)propyloxy) propyl]-2-methyl (meth)acrylamide, N-2-(meth)acryloxyethyl-O-(methyl-bis-trimethylsiloxy-3-propyl)silyl carbamate, 3-(trimethylsilyl)propylvinyl carbonate, 3-(vinyloxycarbonylthio)propyl-tris(trimethyl-siloxy)silane, 3-[tris(trimethylsiloxy)silyl]propylvinyl carbamate, 3-[tris(trimethylsiloxy)silyl]propyl allyl carbamate, 3-[tris(trimethylsiloxy)silyl]propyl vinyl carbonate, those disclosed in U.S. Pat. Nos. 9,097,840, 9,103,965 and 9,475,827, incorporated herein by reference for the purpose of said chemical compounds), and mixtures thereof. The above silicone-containing vinylic monomers can be obtained from commercial suppliers or can be prepared according to procedures described in U.S. Pat. Nos. 7,214,809, 8,475,529, 8,658,748, 9,097,840, 9,103,965, and 9,475,827 (incorporated herein by reference for the purpose of said procedures).

In some embodiments, a polysiloxane vinylic monomer includes one or more of an α-(meth)acryloxypropyl terminated ω-butyl (or ωo-methyl) terminated polydimethylsiloxane, α-(meth)acryloxy-2-hydroxypropyloxypropyl terminated ω-butyl (or ω-methyl) terminated polydimethylsiloxane, α-(2-hydroxyl-methacryloxypropyloxypropyl)-ω-butyl-decamethylpentasiloxane, α-[3-(meth)acryloxyethoxy-2-hydroxypropyloxypropyl]-terminated ω-butyl (or ω-methyl) terminated polydimethylsiloxane, α-[3-(meth)acryloxy-propyloxy-2-hydroxypropyloxypropyl]-terminated ω-butyl (or ω-methyl) terminated polydimethylsiloxane, α-[3-(meth)acryloxyisopropyloxy-2-hydroxypropyloxypropyl]-terminated ω-butyl (or ω-methyl) terminated polydimethylsiloxane, α-[3-(meth)acryloxybutyloxy-2-hydroxypropyloxypropyl]-terminated ω-butyl (or ω-methyl) terminated polydimethylsiloxane, α-[3-(meth)acryloxyethylamino-2-hydroxypropyloxypropyl]-terminated ω-butyl (or ω-methyl) terminated polydimethylsiloxane, α-[3-(meth)acryloxypropylamino-2-hydroxypropyloxypropyl]-terminated ω-butyl (or ω-methyl) terminated polydimethylsiloxane, α-[3-(meth)acryloxy-butylamino-2-hydroxypropyloxypropyl]-terminated ω-butyl (or ω-methyl) terminated polydimethylsiloxane, α-(meth)acryloxy(polyethylenoxy)-2-hydroxypropyloxypropyl]-terminated ω-butyl (or ω-methyl) terminated polydimethylsiloxane, α-[(meth)acryloxy-2-hydroxypropyloxy-ethoxypropyl]-terminated ω-butyl (or ω-methyl) terminated polydimethylsiloxane, α-[(meth)acryloxy-2-hydroxypropyl-N-ethylaminopropyl]-terminated ω-butyl (or ω-methyl) terminated polydimethylsiloxane, α-[(meth)acryloxy-2-hydroxypropyl-aminopropyl]-terminated ω-butyl (or ω-methyl) terminated polydimethylsiloxane, α-[(meth)acryloxy-2-hydroxypropyloxy-(polyethylenoxy) propyl]-terminated ω-butyl (or ω-methyl) terminated polydimethylsiloxane, α-(meth)acryloylamidopropyloxypropyl terminated ω-butyl (or ω-methyl) terminated polydimethylsiloxane, α-N-methyl-(meth)acryloylamidopropyloxypropyl terminated ω-butyl (or ω-methyl) terminated polydimethylsiloxane, α-[3-(meth)acrylamidoethoxy-2-hydroxypropyloxy-propyl]-terminated ω-butyl (or ω-methyl) polydimethylsiloxane, α-[3-(meth)acrylamidopropyloxy-2-hydroxypropyloxypropyl]-terminated ω-butyl (or ω-methyl) terminated polydimethylsiloxane, α-[3-(meth)acrylamidoisopropyloxy-2-hydroxypropyloxypropyl]-terminated ω-butyl (or ω-methyl) terminated polydimethylsiloxane, α-[3-(meth)acrylamidobutyloxy-2-hydroxypropyloxypropyl]-terminated ω-butyl (or ω-methyl) terminated polydimethylsiloxane, α-[3-(meth)acryloylamido-2-hydroxypropyloxypropyl]terminated ω-butyl (or ω-methyl) polydimethylsiloxane, α-[3-[N-methyl-(meth)acryloylamido]-2-hydroxypropyloxypropyl]terminated ω-butyl (or ω-methyl) terminated polydimethylsiloxane, N-methyl-N′-(propyltetra(dimethylsiloxy)-dimethylbutylsilane) (meth)acrylamide, N-(2,3-dihydroxypropane)-N′-(propyltetra(dimethylsiloxy)dimethylbutylsilane) (meth)acrylamide, (meth)acryloylamidopropyltetra(dimethylsiloxy)dimethylbutylsilane, mono-vinyl carbonate-terminated mono-alkyl-terminated polydimethylsiloxanes, mono-vinyl carbamate-terminated mono-alkyl-terminated polydimethylsiloxane, those disclosed in U.S. Pat. Nos. 9,097,840 and 9,103,965, (incorporated herein by reference for the purpose of said chemical compounds), and mixtures thereof. In at least one embodiment, a polysiloxane vinylic monomer can be obtained from commercial suppliers (e.g., Shin-Etsu, Gelest, etc.) or prepared according to procedures described in patents, e.g., U.S. Pat. Nos. 6,867,245, 8,415,405, 8,475,529, 8,614,261, and 9,217,813 (incorporated herein by reference for the purpose of said procedures). In at least one embodiment, a polysiloxane vinylic monomer can be obtained by reacting a hydroxyalkyl (meth)acrylate, (meth)acrylamide, or a (meth)acryloxypolyethylene glycol with a mono-epoxypropyloxypropyl-terminated polydimethylsiloxane. In at least one embodiment, a polysiloxane vinylic monomer can be obtained by reacting a glycidyl (meth)acrylate with a mono-carbinol-terminated polydimethylsiloxane, a mono-aminopropyl-terminated polydimethylsiloxane, or a mono-ethylaminopropyl-terminated polydimethylsiloxane. In at least one embodiment, a polysiloxane vinylic monomer can be obtained by reacting isocyanatoethyl (meth)acrylate with a mono-carbinol-terminated polydimethylsiloxane.

In some embodiments, a crosslinking agent includes a silicone-containing vinylic crosslinker, such as a polysiloxane vinylic crosslinkers, such as di-(meth)acryloyl-terminated polydimethylsiloxanes, di-vinyl carbonate-terminated polydimethylsiloxanes, di-vinyl carbamate-terminated polydimethylsiloxane, N,N,N′,N′-tetrakis(3-methacryloxy-2-hydroxypropyl)-alpha,omega-bis-3-aminopropyl-polydimethylsiloxane, polysiloxane-containing macromer selected from Macromer A, Macromer B, Macromer C, and Macromer D described in U.S. Pat. No. 5,760,100, (incorporated herein by reference for the purpose of said chemical compounds), polysiloxane-containing macromers disclosed in U.S. Pat. Nos. 4,136,250, 4,153,641, 4,182,822, 4,189,546, 4,343,927, 4,254,248, 4,355,147, 4,276,402, 4,327,203, 4,341,889, 4,486,577, 4,543,398, 4,605,712, 4,661,575, 4,684,538, 4,703,097, 4,833,218, 4,837,289, 4,954,586, 4,954,587, 5,010,141, 5,034,461, 5,070,170, 5,079,319, 5,039,761, 5,346,946, 5,358,995, 5,387,632, 5,416,132, 5,451,617, 5,486,579, 5,962,548, 5,981,675, 6,039,913, and 6,762,264, (incorporated herein by reference for the purpose of said chemical compounds), polysiloxane-containing macromers disclosed in U.S. Pat. Nos. 4,259,467, 4,260,725, and 4,261,875, (incorporated herein by reference for the purpose of said chemical compounds), and combinations thereof.

In some embodiments, a crosslinking agent includes a di-(meth)acryloyloxy-terminated polysiloxane vinylic crosslinkers, such as the reaction product(s) of glycidyl methacrylate with di-amino-terminated polydimethylsiloxanes, the reaction product(s) of glycidyl methacrylate with di-hydroxyl-terminated polydimethylsiloxanes, the reaction product(s) of isocyantoethyl (meth)acrylate with di-hydroxyl-terminated polydimethylsiloxanes, or a combination thereof. In at least one embodiment, a di-(meth)acryloyloxy-terminated polysiloxane vinylic crosslinker includes a hydrophilized siloxane unit having one methyl substituent and one monovalent C₄-C₄₀ organic radical substituent as disclosed in U.S. Pat. No. 10,081,697, (incorporated herein by reference for the purpose of said chemical compounds), a chain-extended polysiloxane vinylic crosslinker as disclosed in US201008843A1 and US20120088844A1, (incorporated herein by reference for the purpose of said chemical compounds), a chain-extended polysiloxane vinylic crosslinker as described in U.S. Pat. Nos. 5,034,461, 5,416,132, 5,449,729, 5,760,100, 7,423,074, and 8,529,057, (incorporated herein by reference for the purpose of said chemical compounds), a chain-extended polysiloxane vinylic crosslinker as described in U.S. Pat. App. Pub. No. 2018-0100053, (incorporated herein by reference for the purpose of said chemical compounds), a chain-extended polysiloxane vinylic crosslinker as described in U.S. Pat. App. Pub. No. 2018-0100038, (incorporated herein by reference for the purpose of said chemical compounds), a chain-extended polysiloxane vinylic crosslinker as described in U.S. Pat. No. 8,993,651, (incorporated herein by reference for the purpose of said chemical compounds), α,ω-bis[3-(meth)acrylamidopropyl]-terminated polydimethylsiloxane, α,ω-bis[3-(meth)acryloxypropyl]-terminated polydimethylsiloxane, α,ω-bis[3-(meth)acryloxy-2-hydroxypropyloxypropyl]-terminated polydimethylsiloxane, α,ω-bis[3-(meth)acryloxyethoxy-2-hydroxypropyloxypropyl]-terminated polydimethylsiloxane, α,ω-bis[3-(meth)acryloxy-propyloxy-2-hydroxypropyloxypropyl]-terminated polydimethylsiloxane, α,ω-bis[3-(meth)acryloxy-isopropyloxy-2-hydroxypropyloxypropyl]-terminated polydimethylsiloxane, α, ω-bis[3-(meth)acryloxybutyloxy-2-hydroxypropyloxypropyl]-terminated polydimethylsiloxane, α,ω-bis[3-(meth)acrylamidoethoxy-2-hydroxypropyloxypropyl]-terminated polydimethylsiloxane, α,ω-bis[3-(meth)acrylamidopropyloxy-2-hydroxypropyloxy-propyl]-terminated polydimethylsiloxane, α,ω-bis[3-(meth)acrylamidoisopropyloxy-2-hydroxypropyloxypropyl]-terminated polydimethylsiloxane, α,ω-bis[3-(meth)acrylamide-butyloxy-2-hydroxypropyloxypropyl]-terminated polydimethylsiloxane, α,ω-bis[3-(meth)acryloxyethylamino-2-hydroxypropyloxypropyl]-terminated polydimethylsiloxane, α,ω-bis[3-(meth)acryloxypropylamino-2-hydroxypropyloxypropyl]-terminated polydimethylsiloxane, α,ω-bis[3-(meth)acryloxybutylamino-2-hydroxypropyloxypropyl]-terminated polydimethylsiloxane, α,ω-bis[(meth)acrylamidoethylamino-2-hydroxypropyloxy-propyl]-terminated polydimethylsiloxane, α,ω-bis[3-(meth)acrylamidopropylamino-2-hydroxypropyloxypropyl]-terminated polydimethylsiloxane, α,ω-bis[3-(meth)acrylamide-butylamino-2-hydroxypropyloxypropyl]-terminated polydimethylsiloxane, α,ω-bis[(meth)acryloxy-2-hydroxypropyloxy-ethoxypropyl]-terminated polydimethylsiloxane, α,ω-bis[(meth)acryloxy-2-hydroxypropyl-N-ethylaminopropyl]-terminated polydimethylsiloxane, α,ω-bis[(meth)acryloxy-2-hydroxypropyl-aminopropyl]-polydimethylsiloxane, α,ω-bis[(meth)acryloxy-2-hydroxypropyloxy-(polyethylenoxy) propyl]-terminated polydimethylsiloxane, α,ω-bis[(meth)acryloxyethylamino-carbonyloxy-ethoxypropyl]-terminated polydimethylsiloxane, α,ω-bis[(meth)acryloxyethylamino-carbonyloxy-(polyethylenoxy)propyl]-terminated polydimethylsiloxane, or a combination thereof.

In at least one embodiment, a hydrophilic vinylic monomer includes alkyl (meth)acrylamides, hydroxyl-containing acrylic monomers, amino-containing acrylic monomers, carboxyl-containing acrylic monomers, N-vinyl amide monomers, methylene-containing pyrrolidone monomers (e.g., pyrrolidone derivatives each having a methylene group connected to the pyrrolidone ring at 3- or 5-position), acrylic monomers having a C₁-C₄ alkoxyethoxy group, vinyl ether monomers, allyl ether monomers, phosphorylcholine-containing vinylic monomers, N-2-hydroxyethyl vinyl carbamate, N-carboxyvinyl-β-alanine (VINAL), N-carboxyvinyl-α-alanine, and combinations thereof.

An alkyl (meth)acrylamides may include one or more of (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, and combinations thereof.

A hydroxyl-containing acrylic monomer may include one or more of N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, or combinations thereof.

An amino-containing acrylic monomer may include one or more of N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-3-aminopropyl (meth)acrylamide, N-3-methylaminopropyl (meth)acrylamide, N-3-dimethylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-ethylaminopropyl (meth)acrylate, 3-amino-2-hydroxypropyl (meth)acrylate, trimethylammonium 2-hydroxy propyl (meth)acrylate hydrochloride, dimethylaminoethyl (meth)acrylate, or combinations thereof.

A carboxyl-containing acrylic monomer may include one or more of 2-(meth)acrylamidoglycolic acid, (meth)acrylic acid, ethylacrylic acid, and combinations thereof.

A N-vinyl amide monomer may include one or more of N-vinylpyrrolidone (sometimes referred to as N-vinyl-2-pyrrolidone), N-vinyl-3-methyl-2-pyrrolidone, N-vinyl-4-methyl-2-pyrrolidone, N-vinyl-5-methyl-2-pyrrolidone, N-vinyl-6-methyl-2-pyrrolidone, N-vinyl-3-ethyl-2-pyrrolidone, N-vinyl-4,5-dimethyl-2-pyrrolidone, N-vinyl-5,5-dimethyl-2-pyrrolidone, N-vinyl-3,3,5-trimethyl-2-pyrrolidone, N-vinyl piperidone (sometimes referred to as N-vinyl-2-piperidone), N-vinyl-3-methyl-2-piperidone, N-vinyl-4-methyl-2-piperidone, N-vinyl-5-methyl-2-piperidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl caprolactam (sometimes referred to as N-vinyl-2-caprolactam), N-vinyl-3-methyl-2-caprolactam, N-vinyl-4-methyl-2-caprolactam, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinyl-N-methyl acetamide, N-vinyl formamide, N-vinyl acetamide, N-vinyl isopropylamide, N-vinyl-N-ethyl acetamide, N-vinyl-N-ethyl formamide, and mixtures thereof. In at least one embodiment, the N-vinyl amide monomer is N-vinylpyrrolidone, N-vinyl-N-methyl acetamide, or combinations thereof.

A methylene-containing (═CH₂) pyrrolidone monomer may include one or more of 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, and combinations thereof.

An acrylic monomer having a C₁-C₄ alkoxyethoxy group may include one or more of ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a number average molecular weight of up to 1500, methoxy-poly(ethylene glycol)ethyl (meth)acrylamide having a number average molecular weight of up to 1500, or combinations thereof.

A vinyl ether monomer may include one or more of ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol) methyl vinyl ether, tri(ethylene glycol) methyl vinyl ether, tetra(ethylene glycol) methyl vinyl ether, poly(ethylene glycol) methyl vinyl ether, and combinations thereof.

An allyl ether monomer may include one or more of allyl alcohol, ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol) methyl allyl ether, tri(ethylene glycol) methyl allyl ether, tetra(ethylene glycol) methyl allyl ether, poly(ethylene glycol) methyl allyl ether, and combinations thereof.

A phosphorylcholine-containing vinylic monomer may include one or more of (meth)acryloyloxyethyl phosphorylcholine (sometimes referred to as MPC and/or 2-((meth)acryloyloxy)ethyl-2′-(trimethylammonio)ethylphosphate), 3-((meth)acryloyloxy) propyl-2′-(trimethylammonio)ethylphosphate), 4-((meth)acryloyloxy) butyl-2′-(trimethylammonio)-ethylphosphate, 2-[(meth)acryloylamino]ethyl-2′-(trimethylammonio)-ethylphosphate, 3-[(meth)acryloylamino]propyl-2-(trimethylammonio)ethylphosphate, 4-[(meth)acryloylamino]butyl-2′-(trimethylammonio)ethylphosphate, 5-((meth)acryloyloxy)-pentyl-2′-(trimethylammonio)ethyl phosphate, 6-((meth)acryloyloxy)hexyl-2′-(trimethylammonio)ethylphosphate, 2-((meth)acryloyloxy)ethyl-2′-(triethylammonio)ethylphosphate, 2-((meth)acryloyloxy)ethyl-2′-(tripropylammonio)ethylphosphate, 2-((meth)acryloyloxy)ethyl-2′-(tributylammonio)ethyl phosphate, 2-((meth)acryloyoxy)propyl-2′-(trimethylammonio)-ethylphosphate, 2-((meth)acryloyloxy)butyl-2′-(trimethylammonio)-ethylphosphate, 2-((meth)acryloyloxy)pentyl-2′-(trimethylammonio)ethylphosphate, 2-((meth)acryloyloxy)hexyl-2′-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)-ethylphosphate, 2-(vinylcarbonylamino)ethyl-2′-(trimethylammonio)ethylphosphate, 2-(allyloxycarbonylamino)ethyl-2′-(trimethylammonio)ethyl phosphate, 2-(butenoyloxy)ethyl-2′-(trimethylammonio)ethylphosphate, and combinations thereof.

In some embodiments, the silicone hydrogel material can additionally and/or alternatively include repeating units of one or more hydrophobic vinylic monomers and one or more non-silicone vinylic crosslinkers.

A hydrophobic vinylic monomer may include one or more of methyl (meth)acrylate, ethyl (meth)acrylate, propyl (meth)acrylate, isopropyl (meth)acrylate, cyclohexyl (meth)acrylate, 2-ethylhexyl (meth)acrylate, vinyl acetate, vinyl propionate, vinyl butyrate, vinyl valerate, styrene, chloroprene, vinyl chloride, vinylidene chloride, (meth)acrylonitrile, 1-butene, butadiene, vinyl toluene, vinyl ethyl ether, perfluorohexylethyl-thio-carbonyl-aminoethyl-methacrylate, isobornyl (meth)acrylate, trifluoroethyl (meth)acrylate, hexafluoro-isopropyl (meth)acrylate, hexafluorobutyl (meth)acrylate, and combinations thereof.

A non-silicone vinylic cross-linking agent may include one or more of ethylene glycol di-(meth)acrylate, diethyleneglycol di-(meth)acrylate, triethyleneglycol di-(meth)acrylate, tetraethyleneglycol di-(meth)acrylate, glycerol di-(meth)acrylate, 1,3-propanediol di-(meth)acrylate, 1,3-butanediol di-(meth)acrylate, 1,4-butanediol di-(meth)acrylate, glycerol 1,3-diglycerolate di-(meth)acrylate, ethylenebis[oxy(2-hydroxypropane-1,3-diyl)]di-(meth)acrylate, bis[2-(meth)acryloxyethyl]phosphate, trimethylolpropane di-(meth)acrylate, 3,4-bis[(meth)acryloyl]tetrahydrofuan, diacrylamide, dimethacrylamide, N,N-di(meth)acryloyl-N-methylamine, N,N-di(meth)acryloyl-N-ethylamine, N,N′-methylene bis(meth)acrylamide, N,N′-ethylene bis(meth)acrylamide, N,N′-dihydroxyethylene bis(meth)acrylamide, N,N′-propylene bis(meth)acrylamide, N,N′-2-hydroxypropylene bis(meth)acrylamide, N,N′-2,3-dihydroxybutylene bis(meth)acrylamide, 1,3-bis(meth)acrylamidepropane-2-yl dihydrogen phosphate, piperazine diacrylamide, tetraethyleneglycol divinyl ether, triethyleneglycol divinyl ether, diethyleneglycol divinyl ether, ethyleneglycol divinyl ether, triallyl isocyanurate, triallyl cyanurate, trimethylopropane trimethacrylate, pentaerythritol tetramethacrylate, bisphenol A dimethacrylate, allylmethacrylate, allylacrylate, N-allyl-methacrylamide, N-allyl-acrylamide, and combinations thereof. In one or more embodiment, a non-silicone vinylic cross-linking agent is selected from tetra(ethyleneglycol) di-(meth)acrylate, tri(ethyleneglycol) di-(meth)acrylate, ethyleneglycol di-(meth)acrylate, di(ethyleneglycol) di-(meth)acrylate, tetraethyleneglycol divinyl ether, triethyleneglycol divinyl ether, diethyleneglycol divinyl ether, ethyleneglycol divinyl ether, triallyl isocyanurate, triallyl cyanurate, and combinations thereof.

In some embodiments, the bulk layer 102 of a coated contact lens 100 includes repeating units of a UV-absorbing vinylic monomer, such as a high energy violet light (HEVL) absorbing vinylic monomer (e.g., light having wavelength between 380 nm and 440 nm).

A UV-absorbing and HEVL-absorbing vinylic monomer may include one or more of 2-(2-hydroxy-5-vinylphenyl)-2H-benzotriazole, 2-(2-hydroxy-5-acrylyloxyphenyl)-2H-benzotriazole, 2-(2-hydroxy-3-methacrylamido methyl-5-tert octylphenyl) benzotriazole, 2-(2′-hydroxy-5′-methacrylamidophenyl)-5-chlorobenzotriazole, 2-(2′-hydroxy-5′-methacrylamidophenyl)-5-methoxybenzotriazole, 2-(2′-hydroxy-5′-methacryloxypropyl-3′-t-butyl-phenyl)-5-chlorobenzotriazole, 2-(2′-hydroxy-5′-methacryloxypropylphenyl) benzotriazole, 2-hydroxy-5-methoxy-3-(5-(trifluoromethyl)-2H-benzo[d][1,2,3]triazol-2-yl)benzyl methacrylate (WL-1), 2-hydroxy-5-methoxy-3-(5-methoxy-2H-benzo[d][1,2,3]triazol-2-yl)benzyl methacrylate (WL-5), 3-(5-fluoro-2H-benzo[d][1,2,3]triazol-2-yl)-2-hydroxy-5-methoxybenzyl methacrylate (WL-2), 3-(2H-benzo[d][1,2,3]triazol-2-yl)-2-hydroxy-5-methoxybenzyl methacrylate (WL-3), 3-(5-chloro-2H-benzo[d][1,2,3]triazol-2-yl)-2-hydroxy-5-methoxybenzyl methacrylate (WL-4), 2-hydroxy-5-methoxy-3-(5-methyl-2H-benzo[d][1,2,3]triazol-2-yl)benzyl methacrylate (WL-6), 2-hydroxy-5-methyl-3-(5-(trifluoromethyl)-2H-benzo[d][1,2,3]triazol-2-yl)benzyl methacrylate (WL-7), 4-allyl-2-(5-chloro-2H-benzo[d][1,2,3]triazol-2-yl)-6-methoxyphenol (WL-8), 2-{2′-Hydroxy-3′-tert-5′[3″-(4″-vinylbenzyloxy)propoxy]phenyl}-5-methoxy-2H-benzotriazole, phenol, 2-(5-chloro-2H-benzotriazol-2-yl)-6-(1,1-dimethylethyl)-4-ethenyl-(UVAM), 2-[2′-hydroxy-5′-(2-methacryloxyethyl)phenyl)]-2H-benzotriazole (2-Propenoic acid, 2-methyl-, 2-[3-(2H-benzotriazol-2-yl)-4-hydroxyphenyl]ethyl ester, Norbloc), 2-{2′-Hydroxy-3′-tert-butyl-5′-[3′-methacryloyloxypropoxy]phenyl}-2H-benzotriazole, 2-{2′-Hydroxy-3′-tert-butyl-5′-[3′-methacryloyloxypropoxy]phenyl}-5-methoxy-2H-benzotriazole (UV13), 2-{2′-Hydroxy-3′-tert-butyl-5′-[3′-methacryloyloxypropoxy]phenyl}-5-chloro-2H-benzotriazole (UV28), 2-[2′-Hydroxy-3′-tert-butyl-5′-(3′-acryloyloxypropoxy) phenyl]-5-trifluoromethyl-2H-benzotriazole (UV23), 2-(2′-hydroxy-5-methacrylamidophenyl)-5-methoxybenzotriazole (UV6), 2-(3-allyl-2-hydroxy-5-methylphenyl)-2H-benzotriazole (UV9), 2-(2-Hydroxy-3-methallyl-5-methylphenyl)-2H-benzotriazole (UV12), 2-3′-t-butyl-2′-hydroxy-5′-(3″-dimethylvinylsilylpropoxy)-2′-hydroxy-phenyl)-5-methoxybenzotriazole (UV15), 2-(2′-hydroxy-5′-methacryloylpropyl-3′-tert-butyl-phenyl)-5-methoxy-2H-benzotriazole (UV16), 2-(2′-hydroxy-5′-acryloylpropyl-3′-tert-butyl-phenyl)-5-methoxy-2H-benzotriazole (UV16A), 2-Methylacrylic acid 3-[3-tert-butyl-5-(5-chlorobenzotriazol-2-yl)-4-hydroxyphenyl]-propyl ester (16-100, CAS #96478-15-8), 2-(3-(tert-butyl)-4-hydroxy-5-(5-methoxy-2H-benzo[d][1,2,3]triazol-2-yl)phenoxy)ethyl methacrylate (16-102), Phenol, 2-(5-chloro-2H-benzotriazol-2-yl)-6-methoxy-4-(2-propen-1-yl) (CAS #1260141-20-5); 2-[2-Hydroxy-5-[3-(methacryloyloxy)propyl]-3-tert-butylphenyl]-5-chloro-2H-benzotriazole; Phenol, 2-(5-ethenyl-2H-benzotriazol-2-yl)-4-methyl-, homopolymer (9CI) (CAS #83063-87-0). In at least one embodiment, the polymerizable composition comprises about 0.1% to about 3.0% by weight (wt %) of the one or more UV-absorbing vinylic monomers related to the amount of all polymerizable components in the polymerizable composition, such as about 0.2 wt % to about 2.5 wt %, such as about 0.3 wt % to about 2.0 wt %.

In some embodiments, a bulk layer composition for forming the bulk layer 102 of a coated contact lens 100 includes a photoinitiator compound, such as a Germanium-based Norrish Type I photoinitiator. The a Germanium-based Norrish Type I photoinitiator may be photoactive when exposed to a light source including a light in the region of about 400 to about 550 nm to initiate a free-radical polymerization. A Germanium-based Norrish Type I photoinitiator may include one or more acylgermanium compounds, as described in U.S. Pat. No. 7,605,190.

In some embodiments, a bulk layer composition for forming the bulk layer 102 of a coated contact lens 100 includes one or more of a free-radical initiator (e.g., thermal polymerization initiators or photoinitiators), a visibility tinting agent (e.g., reactive dyes, polymerizable dyes, pigments, or mixtures thereof), antimicrobial agents (e.g., silver nanoparticles), a bioactive agent, leachable tear-stabilizing agents, and mixtures thereof.

A thermal polymerization initiator may include one or more peroxides, hydroperoxides, azo-bis(alkyl- or cycloalkylnitriles), persulfates, percarbonates, or mixtures thereof. In at least one embodiment, a thermal polymerization initiators includes one or more of benzoyl peroxide, t-butyl peroxide, t-amyl peroxybenzoate, 2,2-bis(tert-butylperoxy)butane, 1,1-bis(tert-butylperoxy)cyclohexane, 2,5-Bis(tert-butylperoxy)-2,5-dimethylhexane, 2,5-bis(tert-butylperoxy)-2,5-dimethyl-3-hexyne, bis(1-(tert-butylperoxy)-1-methylethyl) benzene, 1,1-bis(tert-butylperoxy)-3,3,5-trimethylcyclohexane, di-t-butyl-diperoxyphthalate, t-butyl hydroperoxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl)peroxy dicarbonate (Perkadox 16S), di(2-ethylhexyl)peroxy dicarbonate, t-butylperoxy pivalate (Lupersol 11), t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-Azobis[2-(2-imidazolin-2-yl)propane]dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof.

A photoinitiator may include one or more of benzoin methyl ether, diethoxyacetophenone, a benzoylphosphine oxide, 1-hydroxycyclohexyl phenyl ketone, and Darocur and Irgacur type Germanium-based Norrish Type I photoinitiators (e.g., those described in U.S. Pat. No. 7,605,190 (incorporated herein by reference for the purpose of said chemical compounds)). In at least one embodiment, a photoinitiator is a benzoylphosphine initiator, such as 2,4,6-trimethylbenzoyldiphenylophosphine oxide, bis-(2,6-dichlorobenzoyl)-4-N-propylphenylphosphine oxide, and/or bis-(2,6-dichlorobenzoyl)-4-N-butylphenylphosphine oxide. In at least one embodiment, the photoinitiators is incorporated into a macromer or solution thereof, as described in in EP 632 329 (incorporated herein by reference for the purpose of said chemical compounds).

In some embodiments, the bulk layer 102 is prepared via a thermal polymerization process. The thermal polymerization process may be conducted at a temperature range of about 25° C. to about 120° C., such as 40° C. to about 100° C., for a reaction time of about 1 hr to about 24 hrs, such as about 2 hrs to about 12 hrs. It may be advantageous to degas the components and solvents used in the polymerization reaction prior to conducting the polymerization process.

In some embodiments, the bulk layer 102 is prepared via an actinic polymerization process. The actinic polymerization process may include exposing the bulk layer composition to a lightsource radiating a light of suitable wavelength to initiate the polymerization reaction.

In some embodiments, a coated contact lens 100 has a water content of from about 10 wt % to about 80 wt % (at room temperature, about 22° C. to 28° C.), such as about 20 wt % to about 80 wt %, such as about 30 wt % to about 70 wt %. In some embodiments, a coated contact lens 100 has an elastic modulus of about 0.2 MPa to about 1.5 MPa, such as about 0.3 MPa to about 1.3 MPa, such as about 0.4 MPa to about 1.1 MPa, such as about 0.5 MPa to about 1.0 MPa. In some embodiments, a coated contact lens 100 has a UVB transmittance of about 10% or less between 280 and 315 nanometers, such as about 5% or less, such as about 2.5% or less, such as about 1% or less. In some embodiments, a coated contact lens 100 has a UVA transmittance of about 30% or less between 315 and 380 nanometers, such as about 20% or less, such as about 10% or less, such as about 5% or less. In some embodiments, a coated contact lens 100 has a Violet transmittance of from about 0% to about 70% between 380 nm and 440 nm when fully hydrated, such as about 5% to about 60%, such as about 5% to about 50%, such as about 5% to about 40%.

In some embodiments, the bulk layer 102 formed from the bulk layer composition includes a plurality of hydroxyl groups exposed on a surface thereof. The hydroxyl groups may be present as a result of the chemical composition of the bulk layer 102 (e.g., polyvinyl alcohol), partial-crosslinking of the bulk layer composition during the cure process, and/or from the application of a coating onto the surface of the bulk layer 102. The term “partially-crosslinked” is in reference to a polymeric material in which the crosslinkable groups of the starting materials (e.g., the bulk layer composition) have not fully been consumed.

In at least one embodiment, a coating (not shown) may be applied to the surface of the bulk layer 102. The coating applied to the bulk layer 102 may include a hydrophilic polymer, such as a poly(ethylene glycol) having one sole functional group of NH₂, SH or —COH, a poly(ethylene glycol) having two terminal functional groups selected from —NH₂, —COH, SH, and combinations thereof, and/or a multi-arm poly(ethylene glycol) having one or more functional groups selected from —NH₂, —COH, SH, and combinations thereof. In some embodiments, the coating applied to the bulk layer 102 includes a monoamino-, monocarboxyl-, diamino- or dicarboxyl-terminated homo- or copolymer of a non-reactive hydrophilic vinylic monomer. In some embodiments, the coating applied to the bulk layer 102 is a copolymer which is a polymerization product of a composition comprising about 0.1 mol % to about 30 mol % of acrylic acid, methacrylic acid, ethylacrylic acid, 2-(meth)acrylamidoglycolic acid, N-2-aminoethyl (meth)acrylamide, N-2-methylaminoethyl (meth)acrylamide, N-2-ethylaminoethyl (meth)acrylamide, N-3-aminopropyl (meth)acrylamide, N-3-methylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-amino-2-hydroxypropyl (meth)acrylate, or a combination thereof, and at least one non-reactive hydrophilic vinylic monomer selected from acryamide, N,N-dimethylacrylamide, N-vinylpyrrolidone, (meth)acryloyloxyethyl phosphorylcholine, N-vinyl-N-methyl acetamide, glycerol (meth)acrylate, hydroxyethyl (meth)acrylate, N-hydroxyethyl (meth)acrylamide, C₁-C₄-alkoxy polyethylene glycol (meth)acrylate having a weight average molecular weight of up to 400 Daltons, vinyl alcohol, poly(vinyl alcohol), and combination thereof. The non-reactive hydrophilic vinylic monomer may include one or more alkyl (meth)acrylamides, N-2-dimethylaminoethyl (meth)acrylamide, dimethylaminoethyl (meth)acrylate, hydroxyl-containing acrylic monomers, one or more N-vinyl amide monomers, one or more methylene-containing pyrrolidone monomers (e.g., pyrrolidone derivatives each having a methylene group connected to the pyrrolidone ring at 3- or 5-position), one or more acrylic monomers having a C₁-C₄ alkoxyethoxy group, one or more vinyl ether monomers, one or more allyl ether monomers, one or more a phosphorylcholine-containing vinylic monomers, and combinations thereof. In at least one embodiment, the non-reactive hydrophilic vinylic monomer includes at least one of (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)ethylphosphate, 3-[(meth)acryloylamino]propyl-2′-(trimethylammonio)ethylphosphate, 4-[(meth)acryloylamino]butyl-2′-(trimethylammonio)ethylphosphate, (meth)acrylamide, dimethyl (meth)acrylamide, N-2-hydroxylethyl (meth)acrylamide, N,N-bis(hydroxyethyl) (meth)acrylamide, N-2,3-dihydroxypropyl (meth)acrylamide, N-tris(hydroxymethyl)methyl (meth)acrylamide, 2-hydroxyethyl (meth)acrylate, glycerol methacrylate (GMA), tetra(ethylene glycol) (meth)acrylate, poly(ethylene glycol)ethyl (meth)acrylamide having a number average molecular weight of up to 1500, poly(ethylene glycol) (meth)acrylate having a number average molecular weight of up to 1500, N-vinylpyrrolidone, N-vinyl-N-methyl acetamide, N-vinyl formamide, N-vinyl acetamide, 1-methyl-3-methylene-2-pyrrolidone, 1-methyl-5-methylene-2-pyrrolidone, 5-methyl-3-methylene-2-pyrrolidone, tetra(ethylene glycol) methyl ether (meth)acrylate, methoxypoly(ethylene glycol)ethyl (meth)acrylamide having a number average molecular weight of up to 1500, C₁-C₄-alkoxy polyethylene glycol (meth)acrylate having a weight average molecular weight of up to 1500, tetra(ethylene glycol) monovinyl ether, poly(ethylene glycol) monovinyl ether, tetra(ethylene glycol) methyl vinyl ether, poly(ethylene glycol) methyl vinyl ether, tetra(ethylene glycol) monoallyl ether, poly(ethylene glycol) monoallyl ether, tetra(ethylene glycol) methyl allyl ether, poly(ethylene glycol) methyl allyl ether, vinyl alcohol, allyl alcohol, and combinations thereof. In at least one embodiment, the non-reactive hydrophilic vinylic monomer is selected from one or more of (meth)acryloyloxyethyl phosphorylcholine, (meth)acryloyloxypropyl phosphorylcholine, 4-((meth)acrylayloxy)butyl-2″-(trimethylammonio)ethylphosphate, 2-[(meth)acryloyiamino]ethyl-2′-(trimethylammonio)ethylphosphate, 3-[(meth)acryloylamino]propyl-2′-(trimethylammonio)ethylphosphate, 4-[(meth)acryloylarnino]butyl-2′-(trimethylammonio)ethylphosphate, (meth)acrylamide, dimethyl (meth)acrylamide, N-2-hydroxylethyl (meth)acrylamide, N,N-bis(hydroxyethyl) (meth)acrylamide, N-2,3-dihydroxypropyl (meth)acrylamide, N-tris(hydroxymethyl)methyl (meth)acrylamide, 2-hydroxyethyl (meth)acrylate, glycerol methacrylate (GMA), poly(ethylene glycol)ethyl (meth)acrylamide having a number average molecular weight of up to 1500, poly(ethylene glycol) (meth)acrylate having a number average molecular weight of up to 1500, N-vinylpyrrolidone, N-vinyl-N-methyl acetamide, methoxypoly(ethylene glycol)ethyl (meth)acrylamide having a number average molecular weight of up to 1500, methoxy polyethylene glycol (meth)acrylate having a weight average molecular weight of up to 1500, poly(ethylene glycol) monovinyl ether, poly(ethylene glycol) methyl vinyl ether, poly(ethylene glycol) monoallyl ether, poly(ethylene glycol) methyl allyl ether, vinyl alcohol, allyl alcohol, or combinations thereof. In at least one embodiment, the non-reactive hydrophilic vinylic monomer is selected from (meth)acryloyloxyethyl phosphorylcholine, (meth)acryloyloxypropyl phosphorylcholine, 2-[(meth)acryloylamino]ethyl-2′-(trimethylammonio)ethylphosphate, 3-[(meth)acryloylamino]propyl-2′-(trimethylammonio)ethylphosphate, (meth)acrylamide, dimethyl (meth)acrylamide, N-2-hydroxylethyl (meth)acrylamide, N,N-bis(hydroxyethyl) (meth)acrylamide, N-2,3-dihydroxypropyl (meth)acrylamide, N-tris(hydroxymethyl)methyl (meth)acrylamide, poly(ethylene glycol)ethyl (meth)acrylamide having a number average molecular weight of up to 1500, poly(ethylene glycol) (meth)acrylate having a number average molecular weight of up to 1500, N-vinylpyrrolidone, N-vinyl-N-methyl acetamide, methoxypoly(ethylene glycol)ethyl (meth)acrylamide having a number average molecular weight of up to 1500, methoxy polyethylene glycol (meth)acrylate having a weight average molecular weight of up to 1500, and combinations thereof.

In some embodiments, a water-soluble phospholipid polymer (e.g., 104 of FIG. 1) is disposed on the coating applied to the surface of the bulk layer 102 and/or disposed on a surface of the bulk layer 102 to form a coated contact lens 100. The water-soluble phospholipid polymer may be capable of forming a hydrogel layer on the surface of the contact lens to form a coated lens. In at least one embodiment, the water-soluble phospholipid polymer includes one or more functional moieties capable of bonding to and/or interacting with the hydroxyl groups exposed on the surface of the bulk layer 102 by covalent bonding, reversible bonding, ionic bonding, or via one or more secondary interactions (e.g., Van der Waals interactions, π-π interactions, and the like).

In at least one embodiment, the water-soluble phospholipid polymer is a phosphorylcholine based polymer, such as a poly(2-methacryloyloxyethyl phosphorylcholine) (PMPC) based polymer. The water-soluble phospholipid polymer may include a polymer composition having one or more of a phosphorylcholine based unit, an acrylic unit, an arylborono based unit, or a combination thereof. In at least one embodiment, the water-soluble phospholipid polymer is a copolymer including a phosphorylcholine based unit and an acrylic unit, an arylborono based unit, or a combination thereof. The water-soluble phospholipid copolymer may include a random copolymer, a block copolymer, an alternating copolymer, or a statistical copolymer.

In some embodiments, the water-soluble phospholipid polymer can be represented by formula (I):

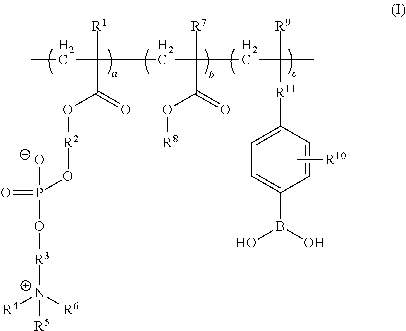

wherein,
R¹, R⁷, and R⁹ are each independently either H or CH₃;
R² and R³ are each independently

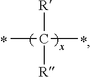

in which x is an integer of 1 to 6, and each of R′ and R″ is independently selected from a hydrogen, a methyl, a ethyl, a butyl, a propyl, a isopropyl, a cyclohexyl, a 2-ethylhexyl(meth)acrylaperfluorohexylethyl-thio-carbonyl-aminoethyl, a isobornyl, a trifluoroethyl, a hexafluoro-isopropyl, a hexafluorobutyl, a ethylene glycol methyl ether, a di(ethylene glycol) methyl ether, a tri(ethylene glycol) methyl ether, a tetra(ethylene glycol) methyl ether, or a C₁-C₄-alkoxy poly(ethylene glycol);
R⁴, R⁵, and R⁶ are each independently a C₁-C₄ alkyl;
R⁸ is selected from a methyl, a ethyl, a butyl, a propyl, a isopropyl, a cyclohexyl, a 2-ethylhexyl(meth)acrylaperfluorohexylethyl-thio-carbonyl-aminoethyl, a isobornyl, a trifluoroethyl, a hexafluoro-isopropyl, a hexafluorobutyl, a ethylene glycol methyl ether, a di(ethylene glycol) methyl ether, a tri(ethylene glycol) methyl ether, a tetra(ethylene glycol) methyl ether, or a C₁-C₄-alkoxy poly(ethylene glycol);
R¹¹ is either a bond, a C₁-C₂ alkylene divalent radical, or a divalent radical of

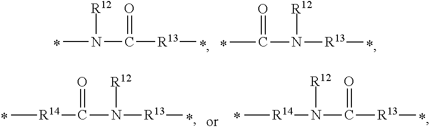

wherein R¹² is H or a C₁-C₄ alkyl, R¹³ is CH(OH) or a C₁-C₄ alkylene divalent radical, and R¹⁴ is a C₁-C₄ alkylene divalent radical;
R¹⁰ is either H, NO₂, F, Cl, or CF₃, wherein a R¹⁰ group is present at each carbon position around the phenyl ring not occupied by a boronic acid group; and
a, b, and c, are each independently an integer of 1 or greater, such as 1 to 5,000.

In some embodiments, the water-soluble phospholipid polymer of formula (I) has a number average molecular weight (Mn) of about 50 kDa to about 100 kDa, such as about 60 kDa to about 90 kDa, such as about 70 kDa to about 80 kDa, alternatively about 50 kDa to about 60 kDa, alternatively about 60 kDa to about 70 kDa, alternatively about 80 kDa to about 90 kDa, alternatively about 90 kDa to about 100 kDa. In some embodiments, the water-soluble phospholipid polymer has a weight average molecular weight (Mw) of about 60 kDa to about 300 kDa, such as about 80 kDa to about 250 kDa, such as about 100 kDa to about 200 kDa, alternatively about 60 kDa to about 80 kDa, alternatively about 80 kDa to about 100 kDa, alternatively about 100 kDa to about 150 kDa, alternatively about 150 kDa to about 200 kDa, alternatively about 200 kDa to about 250 kDa, alternatively about 250 kDa to about 300 kDa. In some embodiments, the water-soluble phospholipid polymer has a polydispersity index (PDI) of about 1.5 to about 2.5, such as about 1.7 to about 2.3, such as about 1.9 to about 2.1, alternatively about 1.5 to about 1.7, alternatively about 1.7 to about 1.9, alternatively about 1.9 to about 2, alternatively about 2 to about 2.1, alternatively about 2.1 to about 2.3, alternatively about 2.3 to about 2.5.

In one or more embodiments, the water-soluble phospholipid polymer includes the phosphorylcholine based unit and the acrylic unit at a molar ratio of about 1:1 to about 10:1 (phosphorylcholine based unit:acrylic unit), such as about 2:1 to about 8:1, such as about 4:1 to about 6:1, alternatively about 1:1 to about 2:1, alternatively about 2:1 to about 4:1, alternatively about 6:1 to about 8:1, alternatively about 8:1 to about 10:1. In one or more embodiments, the water-soluble phospholipid polymer includes the phosphorylcholine based unit and the arylborono based unit at a molar ratio of about 5:1 to about 10:1 (phosphorylcholine based unit:arylborono based unit), such as about 6:1 to about 9:1, such as about 7:1 to about 8:1, alternatively about 5:1 to about 6:1, alternatively about 6:1 to about 7:1, alternatively about 8:1 to about 9:1, alternatively about 9:1 to about 10:1. In one or more embodiments, the water-soluble phospholipid polymer includes the acrylic unit and the and the arylborono based unit at a molar ratio of about 1:1 to about 5:1 (acrylic unit:arylborono based unit), such as about 2:1 to about 4:1, such as about 2.5:1 to about 3.5:1, alternatively about 1:1 to about 2:1, alternatively about 2:1 to about 2.5:1, alternatively about 2.5:1 to about 3:1, alternatively about 3:1 to about 3.5:1, alternatively about 3.5:1 to about 4:1, alternatively about 4:1 to about 5:1.

In one or more embodiments, the water-soluble phospholipid polymer is composed of about 45 mol % to about 95 mol % of the phosphorylcholine based unit, such as about 50 mol % to about 90 mol %, such as about 60 mol % to about 80 mol %, alternatively about 45 mol % to about 50 mol %, alternatively about 50 mol % to about 60 mol %, alternatively about 60 mol % to about 70 mol %, alternatively about 70 mol % to about 80 mol %, alternatively about 80 mol % to about 90 mol %, alternatively about 90 mol % to about 95 mol %. In some embodiments, the water-soluble phospholipid polymer is composed of about 2.5 mol % to about 40 mol % of the acrylic unit, such as about 5 mol % to about 35 mol % such as about 10 mol % to about 30 mol %, alternatively about 2.5 mol % to about 5 mol %, alternatively about 5 mol % to about 10 mol %, alternatively about 10 mol % to about 20 mol %, alternatively about 20 mol % to about 30 mol %, alternatively about 30 mol % to about 35 mol %, alternatively about 35 mol % to about 40 mol %. In some embodiments, the water-soluble phospholipid polymer is composed of about 2.5 mol % to about 40 mol % of the arylborono based unit, such as about 5 mol % to about 35 mol % such as about 10 mol % to about 30 mol %, alternatively about 2.5 mol % to about 5 mol %, alternatively about 5 mol % to about 10 mol %, alternatively about 10 mol % to about 20 mol %, alternatively about 20 mol % to about 30 mol %, alternatively about 30 mol % to about 35 mol %, alternatively about 35 mol % to about 40 mol %.

In some embodiments, a phosphorylcholine based unit is prepared from a phosphorylcholine-containing vinylic and/or acrylic monomer, such as (meth)acryloyloxyethyl phosphorylcholine (e.g., 2-((meth)acryloyloxy)ethyl-2′-(trimethylammonio)ethylphosphate), 3-((meth)acryloyloxy) propyl-2′-(trimethylammonio)ethylphosphate), 4-((meth)acryloyloxy) butyl-2′-(trimethylammonio)-ethylphosphate, 2-[(meth)acryloylamino]ethyl-2′-(trimethylammonio)-ethylphosphate, 3-[(meth)acryloylamino]propyl-2-(trimethylammonio)ethylphosphate, 4-[(meth)acryloylamino]butyl-2′-(trimethylammonio)ethylphosphate, 5-((meth)acryloyloxy)-pentyl-2′-(trimethylammonio)ethyl phosphate, 6-((meth)acryloyloxy)hexyl-2′-(trimethylammonio)ethylphosphate, 2-((meth)acryloyloxy)ethyl-2′-(triethylammonio)ethyl-phosphate, 2-((meth)acryloyloxy)ethyl-2′-(tripropylammonio)ethylphosphate, 2-((meth)acryloyloxy)ethyl-2′-(tributylammonio)ethyl phosphate, 2-((meth)acryloyoxy)propyl-2′-(trimethylammonio)-ethylphosphate, 2-((meth)acryloyloxy)butyl-2′-(trimethylammonio)-ethylphosphate, 2-((meth)acryloyloxy)pentyl-2′-(trimethylammonio)ethylphosphate, 2-((meth)acryloyloxy)hexyl-2′-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)-ethylphosphate, 2-(vinylcarbonylamino)ethyl-2′-(trimethylammonio)ethyl-phosphate, 2-(allyloxycarbonylamino)ethyl-2′-(trimethylammonio)ethyl phosphate, 2-(butenoyloxy)ethyl-2′-(trimethylammonio)ethylphosphate, or combinations thereof.

In one or more embodiments, a phosphorylcholine based unit includes one or more of (meth)acryloyloxyethyl phosphorylcholine (sometimes referred to as MPC and/or 2-((meth)acryloyloxy)ethyl-2′-(trimethylammonio)ethylphosphate), 3-((meth)acryloyloxy) propyl-2′-(trimethylammonio)ethylphosphate), 4-((meth)acryloyloxy) butyl-2′-(trimethylammonio)-ethylphosphate, 2-[(meth)acryloylamino]ethyl-2′-(trimethylammonio)-ethylphosphate, 3-[(meth)acryloylamino]propyl-2-(trimethylammonio)ethylphosphate, 4-[(meth)acryloylamino]butyl-2′-(trimethylammonio)ethylphosphate, 5-((meth)acryloyloxy)-pentyl-2′-(trimethylammonio)ethyl phosphate, 6-((meth)acryloyloxy)hexyl-2′-(trimethylammonio)ethylphosphate, 2-((meth)acryloyloxy)ethyl-2′-(triethylammonio)ethylphosphate, 2-((meth)acryloyloxy)ethyl-2′-(tripropylammonio)ethylphosphate, 2-((meth)acryloyloxy)ethyl-2′-(tributylammonio)ethyl phosphate, 2-((meth)acryloyoxy)propyl-2′-(trimethylammonio)-ethylphosphate, 2-((meth)acryloyloxy)butyl-2′-(trimethylammonio)-ethylphosphate, 2-((meth)acryloyloxy)pentyl-2′-(trimethylammonio)ethylphosphate, 2-((meth)acryloyloxy)hexyl-2′-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)-ethylphosphate, 2-(vinylcarbonylamino)ethyl-2′-(trimethylammonio)ethylphosphate, 2-(allyloxycarbonylamino)ethyl-2′-(trimethylammonio)ethyl phosphate, 2-(butenoyloxy)ethyl-2′-(trimethylammonio)ethylphosphate, and combinations thereof.

In some embodiments, the acrylic unit is prepared from an acrylic monomer, such as ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a number average molecular weight of up to 1500, methyl (meth)acrylate, ethyl (meth)acrylate, propyl (meth)acrylate, butyl (meth)acrylate, isopropyl (meth)acrylate, cyclohexyl (meth)acrylate, 2-ethylhexyl (meth)acrylate, (meth)acrylonitrile, perfluorohexylethyl-thio-carbonyl-aminoethyl-methacrylate, isobornyl (meth)acrylate, trifluoroethyl (meth)acrylate, hexafluoro-isopropyl (meth)acrylate, hexafluorobutyl (meth)acrylate, ethylene glycol methyl ether acrylate, di(ethylene glycol) methyl ether acrylate, tri(ethylene glycol) methyl ether acrylate, tetra(ethylene glycol) methyl ether acrylate, C₁-C₄-alkoxy poly(ethylene glycol) acrylate having a number average molecular weight of up to 1500, methyl acrylate, ethyl acrylate, propyl acrylate, butyl acrylate, isopropyl acrylate, cyclohexyl acrylate, 2-ethylhexyl acrylate, perfluorohexylethyl-thio-carbonyl-aminoethyl-acrylate, isobornyl acrylate, trifluoroethyl acrylate, hexafluoro-isopropyl acrylate, hexafluorobutyl acrylate, or combinations thereof.

In some embodiments, the arylborono based units are prepared from arylborono containing monomers, such as 3-vinylphenylboronic acid, 4-vinylboronic acid, 3-(meth)acrylamidophenylboronic acid, 4-(meth)acrylamidophenylboronic acid, a reaction product of an amino-containing phenylboronic acid derivative with (meth)acrylic acid halide, a reaction product of an amino-containing phenylboronic acid derivative with a carboxy-containing vinylic monomer (any one of those described above) in the presence of a carbodiimide (e.g., 1-ethyl-3-(3-dimethylaminopropyl) carbodiimide (EDC), N,N′-dicyclohexylcarbodiimide (DCC), 1-cylcohexyl-3-(2-morpholinoethyl)carbodiimide, diisopropyl carbodiimide, or mixtures thereof) and N-hydroxysuccinimide, a reaction product of a carboxy-containing phenylboronic acid derivative with an amino-containing vinylic monomer (any one of those described above) in the presence of a carbodiimide (e.g., 1-ethyl-3-(3-dimethylaminopropyl) carbodiimide (EDC), N,N′-dicyclohexylcarbodiimide (DCC), 1-cylcohexyl-3-(2-morpholinoethyl)carbodiimide, diisopropyl carbodiimide, or mixtures thereof) and N-hydroxysuccinimide, or combinations thereof. A carboxy-containing phenylboronic acid derivative may include 3-carboxyphenylboronic acid, 4-carboxyphenylboronic acid, 3-boronophenylacetic acid, 4-boronophenylacetic acid, 2-(4-boronophenyl)-2-methylpropanoic acid, 3-(4-boronophenyl)propanoic acid, 3-(3-boronophenyl)propanoic acid, 5-(3-boronophenyl)pentanoic acid, 5-(4-boronophenyl)pentanoic acid, 4-(2-carboxyethyl)-3-nitrophenylboronic acid, 3-(3-carboxypropyonylamino)phenylboronic acid, 3-amino-3-(4-boronophenyl)propanoic acid, or combinations thereof. An amino-containing phenylboronic acid derivative may include 3-aminophenylboronic acid, 4-aminophenylboronic acid, 4-amino-3-nitrophenylboronic acid, 4-amino-4-fluorophenylboronic acid, 2-(aminomethyl)-5-nitrophenylboronic acid, 3-(aminomethyl)-phenylboronic acid, 3-amino-5-nitrophenylboronic acid, 3-amino-3-(4-boronophenyl)propanoic acid, or combinations thereof.

As previously discussed, the water-soluble phospholipid polymer is disposed on the coating applied to the surface of the bulk layer 102 and/or disposed on a surface of the bulk layer 102 to form a coated contact lens 100. The water-soluble phospholipid polymer may be capable of forming a hydrogel layer on the surface of the contact lens to form a coated lens by bonding (covalently or non-covalently (e.g., ionic bond or Van Der Waals forces)) one or more of the functional moieties of the water-soluble phospholipid polymer with the hydroxyl group present on the surface of the bulk layer 102. As such, the water-soluble phospholipid polymer may be applied to the surface of the bulk layer 102 via any suitable method known to one of ordinary skill in the art, such as contacting the water-soluble phospholipid polymer with the bulk layer 102 such that the hydroxyl groups present on the surface of the bulk layer 102 form a bond with the arylborono based unit of the water-soluble phospholipid polymer. Without being bound by theory, the reaction between the hydroxyl groups present on the surface of the bulk layer 102 with the arylborono based unit of the water-soluble phospholipid polymer form a cyclic boronic ester linkage, as illustrated in Scheme 1.

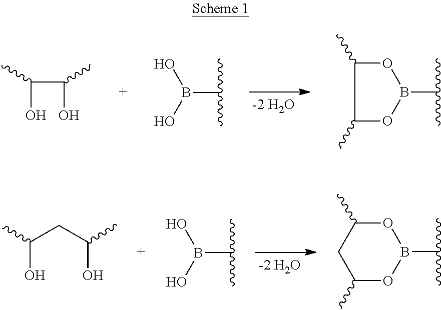

In at least one embodiment, the water-soluble phospholipid polymer is applied to the bulk layer 102 by immersing the bulk layer 102 into an aqueous solution that includes the water-soluble phospholipid polymer, or by spraying the bulk layer 102 with the aqueous solution. In some embodiments, the aqueous solution includes the water-soluble phospholipid polymer in an amount of about 0.01 wt % to about 2.5 wt % of the solution, such as about 0.02 wt % to about 2.0 wt %, such as about 0.05 wt % to about 1.5 wt %, such as about 0.1 wt % to about 1 wt %. The aqueous solution containing the water-soluble phospholipid polymer may be a packaging solution used in preparing an ophthalmic product. In at least one embodiment, the bulk layer 102 is contacted with the aqueous solution, and thus coated with the water-soluble phospholipid polymer, during production of an ophthalmic product.

Contact lens packages (or containers) are known in the art for autoclaving and storing a soft contact lens. In at least one embodiment, a lens package is a blister package which comprises a base and a cover, wherein the cover is detachably sealed to the base, wherein the base includes a cavity for receiving a sterile packaging solution and the contact lens. The sterile packaging solution may contain the water-soluble phospholipid polymer. Lenses are packaged in individual packages, sealed, and sterilized (e.g., by autoclave at about 120° C. or higher for 30 to 90 minutes under pressure) prior to dispensing to users.

The cyclic boronic ester formed via the reaction between the hydroxyl groups exposed on the surface of the contact lens and the arylborono based unit of the water-soluble phospholipid polymer are highly stable under autoclave conditions and thereby the layer (or coating) of the water-soluble phospholipid polymer stably anchored onto the soft contact lens (e.g., the bulk layer 102) for enhancing the surface lubricity of the contact lens.

In at least one embodiment, the aqueous solution is a packaging solution which contains at least one buffering agent and one or more additional components known to one of ordinary skill in the art. Examples of other ingredients include without limitation, tonicity agents, surfactants, antibacterial agents, preservatives, and lubricants (e.g., cellulose derivatives, polyvinyl alcohol, polyvinylpyrrolidone).

In some embodiments, the packaging solution contains a buffering agent in an amount sufficient to maintain a pH of the packaging solution in the desired range. Any known, physiologically compatible buffering agents can be used. A buffering agent may include one or more of boric acid, borates (e.g. sodium borate), citric acid, citrates (e.g. potassium citrate), bicarbonates (e.g. sodium bicarbonate), TRIS (2-amino-2-hydroxymethyl-1,3-propanediol), Bis-Tris (Bis-(2-hydroxyethyl)-imino-tris-(hydroxymethyl)-methane), bis-aminopolyols, triethanolamine, ACES (N-(2-hydroxyethyl)-2-aminoethanesulfonic acid), BES (N,N-Bis(2-hydroxyethyl)-2-aminoethanesulfonic acid), HEPES (4-(2-hydroxyethyl)-1-piperazineethanesulfonic acid), MES (2-(N-morpholino)ethanesulfonic acid), MOPS (3-[N-morpholino]-propanesulfonic acid), PIPES (piperazine-N,N′-bis(2-ethanesulfonic acid), TES (N-[Tris(hydroxymethyl)methyl]-2-aminoethanesulfonic acid), salts thereof, phosphate buffers (e.g. Na₂HPO₄, NaH₂PO₄, and KH₂PO₄ or mixtures thereof). In at least one embodiment, the buffering agents are phosphate buffers, borate buffers, or combinations thereof. The amount of each buffer agent in a packaging solution may be from about 0.001 wt % to about 2 wt % of the solution, such as about 0.01 wt % to about 1 wt %, such as about 0.05 wt % to about 0.30 wt %.

In some embodiments, the packaging solution has a tonicity of about 200 milliosmol (mOsm) to about 450 mOsm, such as about 250 mOsm to about 350 mOsm. The tonicity of a packaging solution can be adjusted by adding organic or inorganic substances which affect the tonicity. Suitable occularly acceptable tonicity agents may include sodium chloride, potassium chloride, and mixtures thereof.

The packaging solution may have a viscosity of from about 1 cP to about 5 cP at approximately 25° C., such as about 2 cP to about 4 cP, such as about 2.5 cP to about 3.5 cP, alternatively about 1 cP to about 2 cP, alternatively about 2 cP to about 2.5 cP, alternatively about 2.5 cP to about 3 cP, alternatively about 3 cP to about 3.5 cP, alternatively about 3.5 cP to about 4 cP, alternatively about 4 cP to about 5 cP.

In some embodiments, the packaging solution includes the water-soluble phospholipid polymer in an amount of about 0.01 wt % to about 2 wt % of the solution, such as about 0.05 wt % to about 1.5 wt %, such as about 0.1 wt % to about 1 wt %, such as about 0.2 wt % to about 0.5 wt %.

In some embodiments, the water-soluble phospholipid polymer may be included in an ophthalmic solution, such as an eye drop, a lens care solution for cleaning and/or disinfecting contact lenses, and/or a contact lens wetting solution.

An ophthalmic solution including the water-soluble phospholipid polymer may also include a buffering agent in an amount sufficient to maintain a pH of about 6.5 to about 9, such as about 7 to about 8.5, such as about 7.5 to about 8, alternatively about 6.5 to about 7, alternatively about 7 to about 7.5, alternatively about 8 to about 8.5, alternatively about 8.5 to about 9. Any of the buffering agents described above may be included in the ophthalmic solution.

In some embodiments, the ophthalmic solution has a viscosity of from about 1 cP to about 5 cP at approximately 25° C., such as about 2 cP to about 4 cP, such as about 2.5 cP to about 3.5 cP, alternatively about 1 cP to about 2 cP, alternatively about 2 cP to about 2.5 cP, alternatively about 2.5 cP to about 3 cP, alternatively about 3 cP to about 3.5 cP, alternatively about 3.5 cP to about 4 cP, alternatively about 4 cP to about 5 cP.

In some embodiments, the packaging solution has a tonicity of about 200 mOsm to about 450 mOsm, such as about 250 mOsm to about 350 mOsm. The tonicity of a packaging solution can be adjusted by adding organic or inorganic substances which affect the tonicity. Suitable occularly acceptable tonicity agents may include sodium chloride, potassium chloride, or mixtures thereof.

A coated contact lens 100 of the present disclosure includes a bulk layer 102 and a water-soluble phospholipid polymer disposed on a surface thereof. The bulk layer 102 may include a cross-linked polymeric material having a plurality of hydroxyl groups disposed on a surface of the bulk layer 102. The plurality of hydroxyl groups may be provided to a surface of the bulk layer 102 via the composition of the bulk layer 102, a coating disposed on the bulk layer 102, a surface treatment applied to the surface of the bulk layer 102, or a combination thereof. The plurality of hydroxyl groups may be accessible from the surface of the bulk layer 102 such that water-soluble phospholipid polymer may be bonded thereto. Such bonding may reversible or permanent. Bonding between the bulk layer 102 and the water-soluble phospholipid polymer is provided by cyclic boronic ester formation (e.g., a reversible bond) via the reaction between the hydroxyl groups exposed on the surface of the contact lens and the arylborono based unit of the water-soluble phospholipid polymer. The cyclic boronic esters formed tether the water-soluble phospholipid polymer to a surface of the bulk layer 102 during the formation of an ophthalmic product. Additionally, the formed cyclic boronic esters may revert back to the hydroxyl groups exposed on the surface of the contact lens and the arylborono based unit of the water-soluble phospholipid polymer during use of the ophthalmic product to release the water-soluble phospholipid polymer to a user's eye, such that the water-soluble phospholipid polymer may act as an ophthalmic comfort agent. Herein, the reversibility of the cyclic boronic esters (e.g., a dynamic covalent chemistry) formed between the hydroxyl groups exposed on the surface of the contact lens and the arylborono based unit of the water-soluble phospholipid polymer is advantageously utilized to produce an ophthalmic product (e.g., a coated contact lens 100) having an extended timeframe of ophthalmic comfort resulting from extended release of a phosphorylcholine based polymer into the eye over an extended period of time.

Although various embodiments of the disclosure have been described using specific terms, devices, and methods, such description is for illustrative purposes only. The words used are words of description rather than of limitation. It is to be understood that changes and variations may be made by those skilled in the art without departing from the spirit or scope of the present disclosure, which is set forth in the following claims.

What is claimed is:

1. A contact lens, comprising:
a bulk layer comprising a crosslinked polymeric material;
a poly(vinyl alcohol) (PVA) layer disposed on the bulk layer; and
a water-soluble phospholipid polymer disposed on the PVA layer, the water-soluble phospholipid polymer comprising a plurality of phosphorylcholine units and a plurality of arylborono units.

2. The contact lens of claim 1, wherein the water-soluble phospholipid polymer is represented by Formula (I): 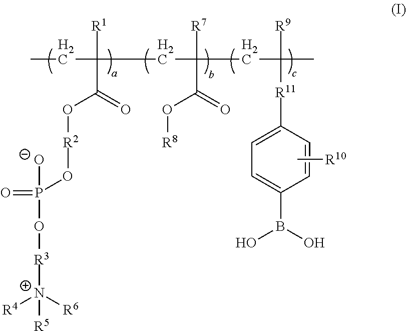
wherein,
R¹, R⁷, and R⁹ are each independently selected from H or CH₃;
R² and R³ are each independently 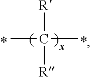
in which x is an integer of 1 to 6, and each of R′ and R″ is independently selected from the group consisting of a hydrogen, a methyl, a ethyl, a butyl, a propyl, a isopropyl, a cyclohexyl, a 2-ethylhexyl(meth)acrylaperfluorohexylethyl-thio-carbonyl-aminoethyl, a isobornyl, a trifluoroethyl, a hexafluoro-isopropyl, a hexafluorobutyl, a ethylene glycol methyl ether, a di(ethylene glycol) methyl ether, a tri(ethylene glycol) methyl ether, a tetra(ethylene glycol) methyl ether, and a C₁-C₄-alkoxy poly(ethylene glycol);
R⁴, R⁵, and R⁶ are each independently a C₁-C₄ alkyl;
R¹ is selected from the group consisting of a methyl, a ethyl, a butyl, a propyl, a isopropyl, a cyclohexyl, a 2-ethylhexyl(meth)acrylaperfluorohexylethyl-thio-carbonyl-aminoethyl, a isobornyl, a trifluoroethyl, a hexafluoro-isopropyl, a hexafluorobutyl, a ethylene glycol methyl ether, a di(ethylene glycol) methyl ether, a tri(ethylene glycol) methyl ether, a tetra(ethylene glycol) methyl ether, or a C₁-C₄-alkoxy poly(ethylene glycol);
R¹¹ is selected from the group consisting of a bond, a C₁-C₂ alkylene divalent radical, and a divalent radical of 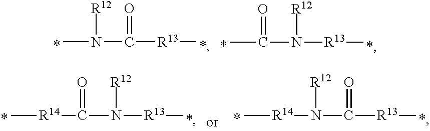
wherein R¹² is H or a C₁-C₄ alkyl, R¹³ is CH(OH) or a C₁-C₄ alkylene divalent radical, and R¹⁴ is a C₁-C₄ alkylene divalent radical;
R¹⁰ is selected from the group consisting of H, NO₂, F, Cl, and CF₃, wherein a R^{∘} group is present at each carbon position around the phenyl ring not occupied by a boronic acid group; and
a, b, and c, are each independently an integer of 1 or greater.

3. The contact lens of claim 2, wherein the water-soluble phospholipid polymer is a random copolymer.

4. The contact lens of claim 2, wherein the water-soluble phospholipid polymer is a block copolymer.

5. The contact lens of claim 1, wherein the water-soluble phospholipid polymer comprises about 60 mol % to about 80 mol % of the phosphorylcholine units.

6. The contact lens of claim 1, wherein the water-soluble phospholipid polymer further comprises a plurality of acrylate units, the water-soluble phospholipid polymer being comprised of about 10 mol % to about 30 mol % of the acrylate units.

7. The contact lens of claim 1, wherein the water-soluble phospholipid polymer comprises about 10 mol % to about 30 mol % of the arylborono units.

8. The contact lens of claim 1, wherein the crosslinked polymeric material comprises a silicone hydrogel material.

9. A contact lens, comprising:
a bulk layer comprising a plurality of hydroxyl groups on a surface thereof; and
a phospholipid polymer disposed on the surface of the bulk layer, the phospholipid polymer comprising a plurality of phosphorylcholine units and a plurality of vinylphenylboronic acid units, wherein the plurality of the vinylphenylboronic acid units is bonded to at least a portion of the plurality of hydroxyl groups.

10. The contact lens of claim 9, wherein the bulk layer comprises a poly(vinyl alcohol) based hydrogel.

11. The contact lens of claim 9, wherein the bulk layer comprises a crosslinked polymeric material and a poly(vinyl alcohol) layer disposed on a surface of the crosslinked polymeric material, the poly(vinyl alcohol) layer providing the plurality of hydroxyl groups to the surface of the bulk layer.

12. The contact lens of claim 9, wherein the phospholipid polymer is represented by Formula (I): 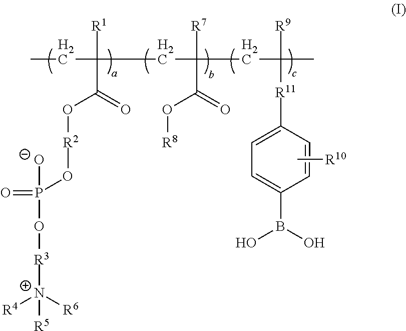
wherein,
R¹, R⁷, and R⁹ are each independently selected from H or CH₃;
R² and R³ are each independently 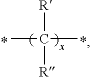
in which x is an integer of 1 to 6, and each of R′ and R″ is independently selected from the group consisting of a hydrogen, a methyl, a ethyl, a butyl, a propyl, a isopropyl, a cyclohexyl, a 2-ethylhexyl(meth)acrylaperfluorohexylethyl-thio-carbonyl-aminoethyl, a isobornyl, a trifluoroethyl, a hexafluoro-isopropyl, a hexafluorobutyl, a ethylene glycol methyl ether, a di(ethylene glycol) methyl ether, a tri(ethylene glycol) methyl ether, a tetra(ethylene glycol) methyl ether, and a C₁-C₄-alkoxy poly(ethylene glycol);
R⁴, R⁵, and R⁶ are each independently a C₁-C₄ alkyl;
R⁸ is selected from the group consisting of a methyl, a ethyl, a butyl, a propyl, a isopropyl, a cyclohexyl, a 2-ethylhexyl(meth)acrylaperfluorohexylethyl-thio-carbonyl-aminoethyl, a isobornyl, a trifluoroethyl, a hexafluoro-isopropyl, a hexafluorobutyl, a ethylene glycol methyl ether, a di(ethylene glycol) methyl ether, a tri(ethylene glycol) methyl ether, a tetra(ethylene glycol) methyl ether, or a C₁-C₄-alkoxy poly(ethylene glycol);
R¹¹ is selected from the group consisting of a bond, a C₁-C₂ alkylene divalent radical, and a divalent radical of 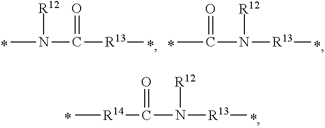 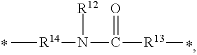
wherein R¹² is H or a C₁-C₄ alkyl, R¹³ is CH(OH) or a C₁-C₄ alkylene divalent radical, and R¹⁴ is a C₁-C₄ alkylene divalent radical;
R¹⁰ is selected from the group consisting of H, NO₂, F, Cl, and CF₃, wherein a Ria group is present at each carbon position around the phenyl ring not occupied by a boronic acid group; and
a, b, and c, are each independently an integer of 1 or greater.

13. The contact lens of claim 12, wherein the phospholipid polymer is a random copolymer.

14. The contact lens of claim 12, wherein the phospholipid polymer is a block copolymer.

15. The contact lens of claim 9, wherein the phospholipid polymer is comprised of about 60 mol % to about 80 mol % of the phosphorylcholine units.

16. The contact lens of claim 9, wherein the phospholipid polymer further comprises a plurality of acrylate units, the phospholipid polymer being comprised of about 10 mol % to about 30 mol % of the acrylate units.

17. The contact lens of claim 9, wherein the phospholipid polymer comprises about 10 mol % to about 30 mol % of the vinylphenylboronic acid unit.

18. A method for producing an ophthalmic product, the method comprising:
curing a lens-forming formulation to form a contact lens, the contact lens comprising:
a crosslinked polymeric material, and
a plurality of hydroxyl groups provided on a surface of the contact lens; and
packaging the contact lens in a container containing a packaging solution, wherein the packaging solution comprises a water-soluble phospholipid polymer comprising a phosphorylcholine unit, an acrylate unit, and a vinylphenylboronic acid unit.

19. The method of claim 18, wherein the water-soluble phospholipid polymer is represented by Formula (I): 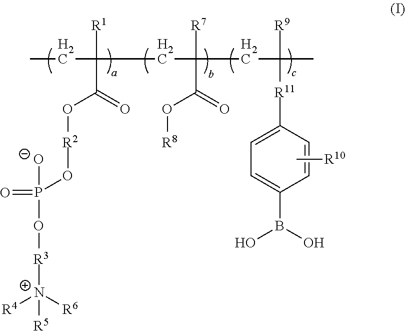
wherein,
R¹, R⁷, and R⁹ are each independently selected from H or CH₃;
R² and R³ are each independently 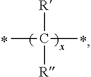
in which x is an integer of 1 to 6, and each of R′ and R″ is independently selected from the group consisting of a hydrogen, a methyl, a ethyl, a butyl, a propyl, a isopropyl, a cyclohexyl, a 2-ethylhexyl(meth)acrylaperfluorohexylethyl-thio-carbonyl-aminoethyl, a isobornyl, a trifluoroethyl, a hexafluoro-isopropyl, a hexafluorobutyl, a ethylene glycol methyl ether, a di(ethylene glycol) methyl ether, a tri(ethylene glycol) methyl ether, a tetra(ethylene glycol) methyl ether, and a C₁-C₄-alkoxy poly(ethylene glycol);
R⁴, R⁵, and R⁶ are each independently a C₁-C₄ alkyl;
R⁸ is selected from the group consisting of a methyl, a ethyl, a butyl, a propyl, a isopropyl, a cyclohexyl, a 2-ethylhexyl(meth)acrylaperfluorohexylethyl-thio-carbonyl-aminoethyl, a isobornyl, a trifluoroethyl, a hexafluoro-isopropyl, a hexafluorobutyl, a ethylene glycol methyl ether, a di(ethylene glycol) methyl ether, a tri(ethylene glycol) methyl ether, a tetra(ethylene glycol) methyl ether, or a C₁-C₄-alkoxy poly(ethylene glycol);
R¹¹ is selected from the group consisting of a bond, a C₁-C₂ alkylene divalent radical, and a divalent radical of 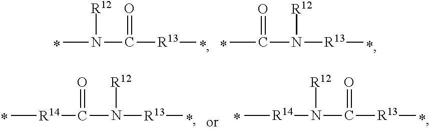
wherein R¹² is H or a C₁-C₄ alkyl, R¹³ is CH(OH) or a C₁-C₄ alkylene divalent radical, and R¹⁴ is a C₁-C₄ alkylene divalent radical;
R¹⁰ is selected from the group consisting of H, NO₂, F, Cl, and CF₃, wherein a R¹⁰ group is present at each carbon position around the phenyl ring not occupied by a boronic acid group; and
a, b, and c, are each independently an integer of 1 or greater.

20. The method of claim 18, wherein the packaging solution comprises about 0.01 wt % to about 2.5 wt % of the water-soluble phospholipid polymer.
